(19) United States
(12) Patent Application Publication
(10) Pub. No.: US 2024/0223585 A1
(43) Pub. Date: Jul. 4, 2024

(54) TRANSPARENT SANITIZATION FOR SYNCHRONIZATION MESSAGES IN TIME SENSITIVE NETWORKING

(71) Applicant: Intel Corporation, Santa Clara, CA (US)

(72) Inventors: Christopher Gutierrez, HILLSBORO, OR (US); Vuk Lesi, Cornelius, OR (US); Marcio Juliato, Portland, OR (US); Manoj Sastry, Portland, OR (US); Shabbir Ahmed, Beaverton, OR (US)

(73) Assignee: Intel Corporation, Santa Clara, CA (US)

(21) Appl. No.: 18/090,682

(22) Filed: Dec. 29, 2022

(51) Int. Cl. H04L 9/40; H04J 3/06

(52) U.S. Cl. CPC H04L 63/1425; H04J 3/0667; H04L 63/1416

(57) ABSTRACT

Techniques include receiving a message with time information at an ingress queue for an ingress interface of an intrusion detection system (IDS), the IDS to monitor a network node of a time-synchronized network (TSN), generating an entrance timestamp for the message, the entrance timestamp to comprise a time value representing when the message is received at the ingress queue of the ingress interface of the IDS, inspecting the message for indications of a security attack by the IDS, generating an exit timestamp for the message, the exit timestamp to comprise a time value representing when the message is received at an egress queue of an egress interface of the IDS, and generating an inspection time interval associated with the IDS, the inspection time interval to represent a time interval between the entrance timestamp and the exit timestamp for the message while transiting the IDS. Other embodiments are described and claimed.

### BACKGROUND

Many computing systems require real-time safety critical features. For example, many autonomous systems, industrial systems, etc., require such systems to have real-time safety-critical features. This often necessitates that timekeeping performance within the system has higher levels of security relative to other aspects of the system. For example, factories employ synchronized robots to accomplish coordinated tasks, often in the presence of human beings. In another example, robots utilize coordination to perform surgeries on humans. As yet another example, self-driving vehicles require synchronization of networked sensing elements to build a precise perception of the environment around the vehicle, including other vehicles, objects, hazards, and persons. Tools relied on to achieve the necessary time performance, synchronization, and bounded latency communication for such time sensitive systems to perform as needed is often referred to as time-synchronized networking.

In general, time-synchronized networking or time-sensitive networking defines a set of standards (and amendments) with the aim to enable time synchronization and deterministic data delivery in converged networks where time-critical (TC) traffic coexists with other types of traffic. Thus, there is a need to provide security for time-synchronized network devices to mitigate the risks associated with disruption in time-synchronized network operation from attacks on the timing of the network.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an aspect of a time-synchronized network (TSN) 102 in accordance with one embodiment.

FIG. 1B illustrates an aspect of a TSN 102 for sensors in accordance with one embodiment.

FIG. 1C illustrates an aspect of a TSN 102 for actuators in accordance with one embodiment.

FIG. 2A illustrates an aspect of a TSN 200a in accordance with one embodiment.

FIG. 2B illustrates an aspect of a timing diagram 200b in accordance with one embodiment.

FIG. 3A illustrates an aspect of a TSN 300a in accordance with one embodiment.

FIG. 3B illustrates an aspect of a timing diagram 300b in accordance with one embodiment.

FIG. 4 illustrates an aspect of a TSN node 104 in accordance with one embodiment.

FIG. 5 illustrates an aspect of an apparatus 500 in accordance with one embodiment.

FIG. 6 illustrates an aspect of a system 600 in accordance with one embodiment.

FIG. 7 illustrates an aspect of an IDS 110 in accordance with one embodiment.

FIG. 8 illustrates an aspect of a system 800 in accordance with one embodiment.

FIG. 9 illustrates a logic flow 900 in accordance with one embodiment.

FIG. 10 illustrates an aspect of a system 1000 in accordance with one embodiment.

FIG. 11 illustrates an aspect of a system 1100 in accordance with one embodiment.

FIG. 12 illustrates an aspect of a matrix 1200 in accordance with one embodiment.

FIG. 13 illustrates an aspect of a matrix 1300 in accordance with one embodiment.

FIG. 14A illustrates an aspect of a clock leader (CL) 1400a in accordance with one embodiment.

FIG. 14B illustrates an aspect of a clock follower (CF) 1400b in accordance with one embodiment.

FIG. 15 illustrates an aspect of a computer-readable medium 1500 in accordance with one embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

The present disclosure is generally directed to time management and recovery techniques for systems operating on strict time requirements, such as systems based on time sensitive networks or time-synchronized networks (TSNs). As noted, TSN defines a set of standards (and amendments) with the aim to enable time synchronization and deterministic data delivery in converged networks where time sensitive traffic coexists with other types of traffic. Various standards have been developed to address time-synchronized or time-sensitive communications. By way of example and not limitation, some standards for enabling time-synchronized communications include those promulgated by the Institute of Electrical and Electronics Engineers (IEEE). For example, IEEE 1588, IEEE 802.1AS and IEEE 802.1Qbv provide systems and methods for synchronizing device clocks. In one example, IEEE 1588 defines a precision time protocol (PTP) for time synchronization across a network. In another example, IEEE 802.1AS defines a time-sensitive networking protocol referred to as a generic PTP (gPTP) for time synchronization across a network, where time sensitive devices (e.g., clock followers) synchronize to a leader clock (e.g., clock leader). In yet another example, IEEE 802.1Qbv defines time-sensitive networking for deterministic latency through traffic scheduling. In still another example, IEEE 60802 defines time-sensitive networking profiles for industrial automation. Other examples include a network time protocol (NTP) which is a networking protocol for clock synchronization between computer systems over packet-switched, variable-latency data networks, network time security (NTS) which is a secure version of NTP, and other time-synchronized network protocols. Embodiments are not limited to these examples.

Time synchronization in a TSN requires tight software-hardware interplay. A device (or node) in a TSN may implement a clock manager as a software component and a hardware clock as a hardware component. The clock manager adjusts timing for the hardware clock to ensure synchronization with a common network time for the TSN. In one embodiment, for example, a precision time protocol (PTP) hardware clock (PHC) is periodically adjusted by a PTP for Linux (PTP4L) software module to account for time offset between a clock leader and a clock follower in PTP-synchronized nodes. When a software component receives incorrect time information, such as a time offset bias within messages carrying time synchronization information, the software can misconfigure or mis-control hardware for the PHC, thereby leading to incorrect timekeeping. For instance, attackers located external to a TSN-capable platform along a network path can tamper with messages carrying time information to synchronize the hardware clock. Examples include malicious switches and/or relays tampering with time-related messages, or external attackers injecting messages into the network, which ends up impacting a time of the nodes downstream. Consequently, system and applications depending on TSN capabilities will consume incorrect time. Accordingly, early detection of a corrupted messages and/or software components for a TSN node is critical within a TSN.

One conventional solution to address this problem is to implement one or more intrusion detection systems (IDSs) to monitor devices within a TSN to identify any abnormal behavior. An IDS implements software, firmware or hardware to support one or more specialized security functions, such as detecting malicious behavior caused by an attacker. The IDS may be implemented on a TSN node or separate from a TSN node. The IDS receives as input messages containing time information for synchronizing a clock of a TSN node with a network time for the TSN. The IDS analyzes the messages to detect anomalies, such as slight modifications to the time information to cause a TSN node to update an internal clock with a wrong network time. Incorrect time synchronization can cause disruptions in time sensitive applications executing on the TSN node, such as causing collisions between cooperative robotic arms or delaying braking in an autonomous vehicle. When the IDS detects abnormalities in messages carrying time information, the IDS generates an alert and takes action to isolate any affected TSN applications and/or TSN nodes from a compromised TSN node.

While deploying multiple IDSs throughout a TSN improves security for the TSN, it presents a challenge where each deployed IDS provides additional latency for messages traversing the TSN. An IDS typically consumes each packet or message as it is communicated through the network. The IDS receives a message on behalf of one or more TSN nodes, scans the message for any abnormalities, and sends the message along to the one or more TSN nodes. The IDS scans for abnormalities such as differences in time information carried by the message. For instance, A TSN periodically sends messages with time information from a clock leader node to one or more clock follower nodes. Attackers positioned in a TSN between the clock leader node and the clock follower nodes, such as in switch nodes or relay nodes, may tamper with the time information carried by the messages. A malicious switch or relay may change timestamps carried by the messages in order to achieve clock drift of downstream clock follower nodes.

Each scan by an IDS, however, adds a certain amount of latency or delay while the IDS performs the scan, sometimes referred to as an “inspection time interval” or “inference delay interval.” Network-based clock synchronization requires protocol messages to capture the incurred delays (e.g., relay residence time and link delay) as messages propagate from clock leader to followers. Protocol messages must precisely reflect the true delay to accurately adjust clock followers to achieve sub-microsecond synchronization. IDSs are positioned in the critical path to inspect and correct synchronization messages due to cyber-attacks.

While a given TSN protocol may attempt to account for various types of message delay throughout a network, such as a residence time delay incurred by a TSN node or a path delay in a peer-to-peer (P2P) protocol, conventional TSN protocols do not account for an inference delay of messages caused by security mechanisms, such as IDSs. IDS delays associated with inspection, inferencing, or correction latency are non-deterministic and thus may reduce the quality of a TSN. Conventional solutions do not provide capabilities to independently inference the reported synchronization message delays. Inspecting protocol messages to inference misuse causes unpredictable message delays (e.g., store, inspect, forward), reducing the timing and overall quality of TSN. As a number of IDS deployed in a TSN increases, so does an accumulated inference delay incurred by a message as it transits the TSN. This problem is further exacerbated by an increase in a length for scanning times to account for an ever-growing attack surface for individual TSN nodes. The accumulated inference delay can itself cause TSN nodes or TSN applications to desynchronize, affecting performance or causing failures. Ironically, the additional security provided by an IDS to prevent desynchronization attacks may in aggregate actually cause a desynchronization event itself. Consequently, a technical gap exists in modern TSNs for inspecting TSN protocol messages without accounting for additional inferencing time, which decreases the quality of time synchronization.

To solve these and other challenges in time-synchronized networking, embodiments implement techniques that account for inspection delay or inferencing delay by updating TSN protocol messages on the fly. In various embodiments, an IDS can be placed at one or more ports of a TSN node, such as an ingress port and/or an egress port, on a synchronization critical path. The IDS can inspect TSN protocol messages, and adjust a correction field with inspection delay or inferencing delay. If misuse is detected, one of the IDS can correct the error or drop the message before a clock follower adjusts their clock.

More particularly, embodiments implement techniques to consider time delays associated with security measures used by a TSN, such as inference times for an IDS, for example. In some embodiments, an IDS may measure an inference time for a message as it transits the IDS. The inference time may include an amount of time representing a time interval between receiving a message by an IDS and sending the message from the IDS, including any processing time incurred by the message in-between. The IDS may consider the measured inference time in TSN timing operations. For instance, the measured inference time may be added to the message, such as a correction value in a correction field of the message. Alternatively, the measured inference time can be reported out-of-band from the message, such as through a central security server or direct path to a destination node (e.g., a clock follower node). In this manner, inference times delaying a message can be accounted for by a TSN node, TSN system, and/or TSN protocol.

In one embodiment, for example, an IDS may be implemented, at least in part, by a computing apparatus that includes processor circuitry. The computing apparatus also includes a memory communicatively coupled to the processor circuitry, the memory to store instructions that when executed by the processor circuitry, causes the processor circuitry to receive a message with time information at an ingress queue for an ingress interface of an IDS, the IDS to monitor a network node of a TSN, the time information to comprise information to synchronize a first clock for a clock leader node and a second clock for clock follower node to a network time for the TSN maintained by the first clock. The processor circuitry may generate an entrance timestamp for the message, the entrance timestamp to comprise a time value representing when the message is received at the ingress queue of the ingress interface of the IDS. The processor circuitry may inspect the message for indications of a security attack by the IDS. The processor circuitry may generate an exit timestamp for the message, the exit timestamp to comprise a time value representing when the message is received at an egress queue of an egress interface of the IDS. The processor circuitry may generate an inspection time interval associated with the IDS, the inspection time interval to represent a time interval between the entrance timestamp and the exit timestamp for the message while transiting the IDS. The processor circuitry may update a correction value of a correction field for the message with the inspection time interval. Other embodiments are described and claimed.

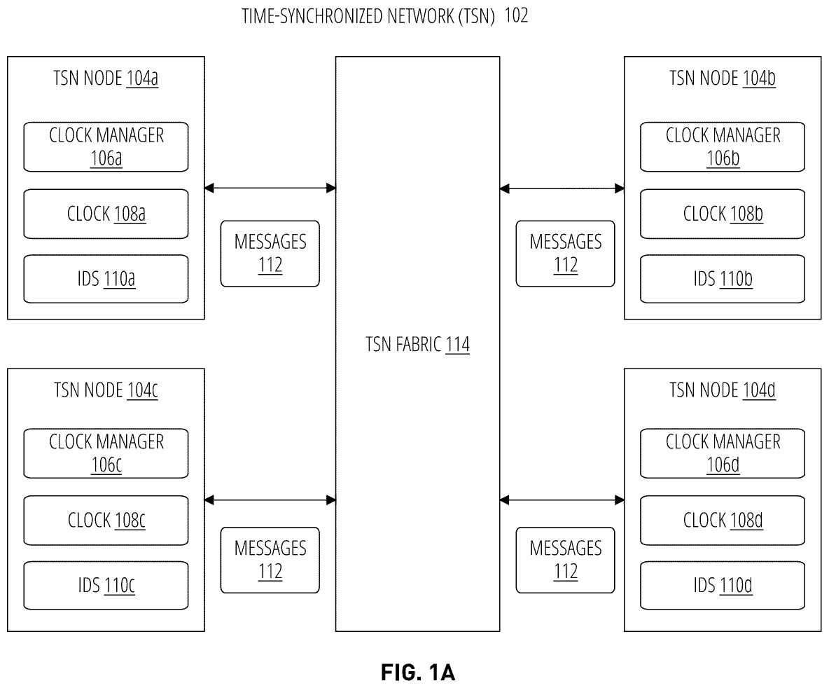

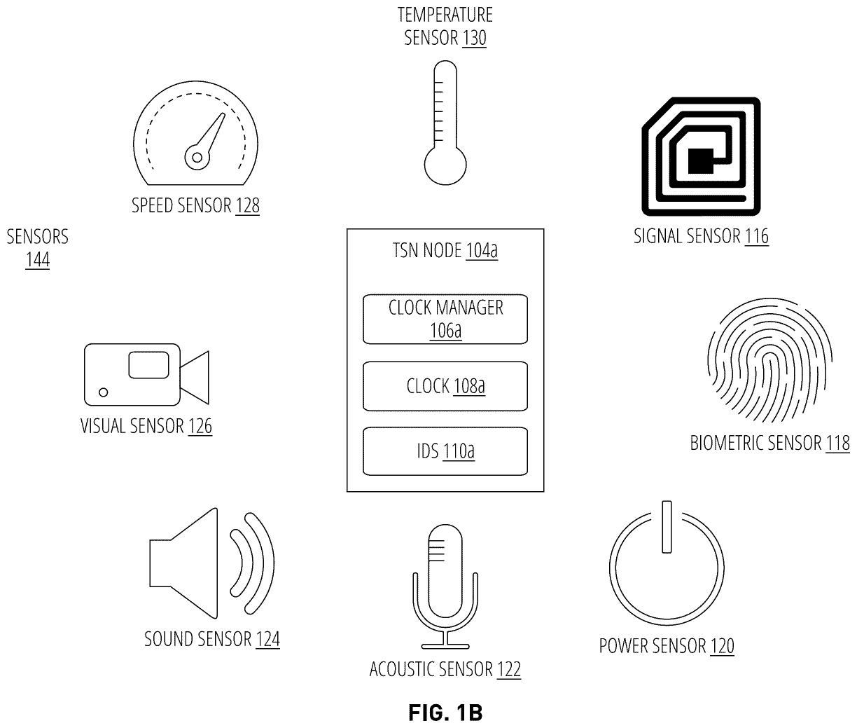

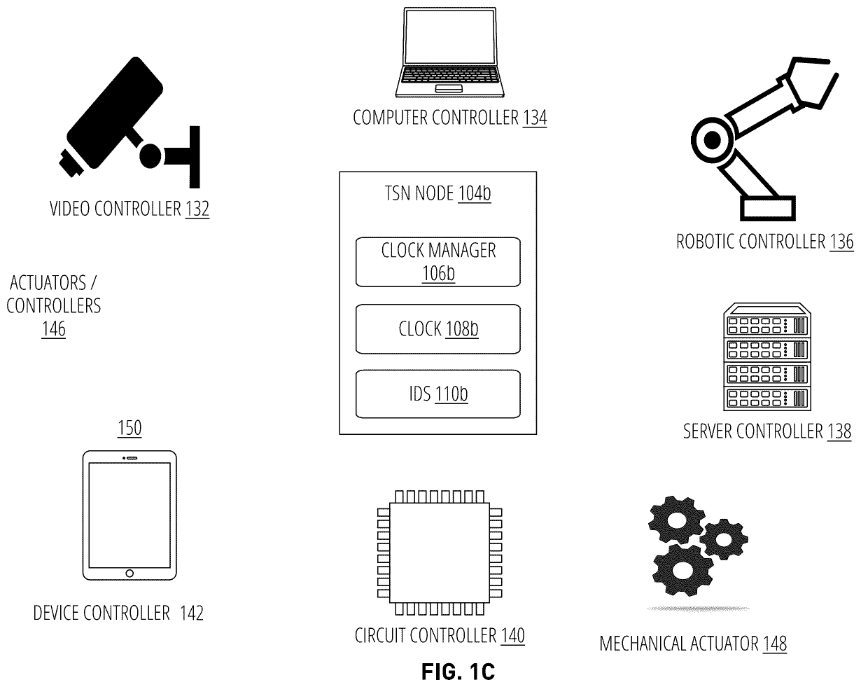

FIG. 1A depicts a time-synchronized network (TSN) 102 implemented according to a TSN standard (e.g., IEEE 1588, IEEE 802.1AS, IEEE 802.1Qbv, or the like). As depicted, TSN 102 includes various TSN nodes 104, such as TSN nodes 104a-d. The TSN nodes 104 may be implemented as different types of nodes for a TSN, such as an origination node, relay nodes, switch nodes or end node. The TSN nodes 104a-d are communicatively coupled via a TSN fabric 114. The TSN fabric 114 can connect the TSN nodes 104a-d using various types of network topology (e.g., mesh, star, etc.) and various types of communications channels (e.g., wired, wireless, fiber optic, buses, etc.). It is noted that the number of nodes in the TSN 102 is selected for purposes of clarity and not limitation. In practice, the TSN 102 can include any number and combination of nodes (e.g., origination nodes, switches, relay nodes, end devices, etc.).

The TSN nodes 104 can communicate with each other via the TSN fabric 114. For instance, the TSN nodes 104 can send messages 112 to each other over one or more communication channels provided by the TSN fabric 114. The messages 112 can include control information and payload information. One type of control information may include time information. The time information may comprise synchronization messages, time update messages or time follow-up messages (among other time protocol messages) for a time protocol used by the TSN 102.

Each TSN node 104 in the TSN 102 includes various hardware and/or software components. As depicted in FIG. 1A, a TSN 104 includes a clock manager 106, a clock 108 and an intrusion detection system (IDS) 110 (referred to herein as an “IDS” or “detector”). For instance, the TSN node 104a includes a clock manager 106a, a clock 108a and an IDS 110a. The TSN node 104b includes a clock manager 106b, a clock 108b and an IDS 110b. The TSN nodes 104c, 104d are similarly configured. It may be appreciated that these are just a few components for a TSN 104, and the TSN 104 can include other standard components for an electronic device, such as network interfaces, radio transceivers, input/output (I/O) components, memory units, processing circuits, controllers, sensors, actuators, mechanical parts, application software, operating system software, TSN-enabled platforms, and so forth.

In various embodiments, the clock manager 106 is implemented as a software component, and the clock 108 is implemented as a hardware component (e.g., “hardware clock” or “clock circuitry”). The IDS 110 can be implemented as a software component, a hardware component, or a combination of both software and hardware components. Embodiments are not limited in this context.

The clock manager 106 generally manages a time (e.g., clock signals) generated by the clock 108. A key component in clock synchronization mechanisms is the clock manager software. In a time-synchronized network such as the TSN 102, this component tightly interacts with network hardware (e.g., Ethernet/Wi-Fi) to obtain Precision Time Protocol (PTP) message timestamps, as well as with PTP clock hardware to implement suitable phase/frequency corrections in order to synchronize with a clock leader. The clock manager 106 typically implements a “clock servo.” A clock servo is a control algorithm that periodically takes as input some measurement (or estimate) of clock offset to a reference clock, and computes as output either time (e.g., phase) or frequency adjustment to compensate for the given offset.

The clock 108 is generally a hardware clock that implements clock circuitry to generate signals for digital electronics implemented by the TSN node 104. In electronics and especially synchronous digital circuits, a clock signal oscillates between a high and a low state and is used to coordinate actions of the digital circuits. A clock signal is produced by a clock generator. Although more complex arrangements are used, the most common clock signal is in the form of a square wave with a 50% duty cycle, usually with a fixed, constant frequency. Circuits using the clock signal for synchronization may become active at either the rising edge, falling edge, or, in the case of double data rate, both in the rising and in the falling edges of the clock cycle. The clock 108 generates clock signals under control of the clock manager 106. The clock 108 can be implemented using any suitable hardware having a timing accuracy required by a given device or network. In the TSN 102, the clock 108 can be implemented as a PHC, although other hardware clocks can be implemented as well. Embodiments are not limited in this context.

In normal operation, a network interface (not shown) for a TSN node 104 can receive messages 112 that include time information representative of a network time for the TSN 102. The clock manager 106 can receive the time information from the network interface, analyze the time information, and determine whether time adjustments are needed for the clock 108. When time adjustments are needed, the clock manager 106 generates control information and sends the control information to the clock 108. The clock 108 receives the clock manager control information, and adjusts a parameter for the clock 108, such as a phase or frequency for the clock signals generated by the clock 108.

The IDS 110 generally monitors the clock manager 106 to detect abnormal or malicious behavior of the TSN 102. In general, the IDS 110 is a device or software application that monitors a device, network or systems for malicious activity or policy violations. The IDS 110 may be specifically tuned to detect a timing attack, such as a desynchronization attack, or other TSN specific attack vector. Any intrusion activity or violation is typically reported either to other devices in the same network, an administrator, and/or collected centrally using a security information and event management (SIEM) system. A SIEM system combines outputs from multiple sources and uses alarm filtering techniques to distinguish malicious activity from false alarms. In addition to the TSN node 104, the IDS 110 may be implemented for other devices in the TSN, such as relay nodes 104a-104c, to provide a more comprehensive security solution to an attacker.

The IDS 110 can operate in an on-line or off-line mode. When operating in an on-line mode, the IDS 110 examines network traffic in real time. It performs an analysis of passing traffic on the entire subnet, and matches the traffic that is passed on the subnets to the library of known attacks. For instance, it analyses the message 310 (e.g., a TSN timing message) and applies some rules, to decide if it is an attack or not. Off-line mode typically deals with stored data and passes it through some processes to decide if it is an attack or not. For the offline case, a message may be replicated for offline analysis. It may be replicated in hardware without incurring a memory copy. However, a software solution may copy the message from the queue for later analysis. In either mode, once an attack is identified, or abnormal behavior is sensed, an alert can be sent to a SIEM, a network administrator, or a software application to automatically implement security protocols, such as dropping the message 112, isolating an infected device guarded by the IDS 110, and/or re-configuring one or more network paths for impacted devices in the TSN network.

The IDS 110 can utilize any number of different detection methods to detect an attack. For instance, the IDS 110 may implement a signature-based method, a statistical anomaly-based method, a stateful protocol analysis method, machine-learning based, or some combination of all four methods. A signature-based IDS monitors packets in the network and compares with pre-configured and pre-determined attack patterns known as signatures. A statistical anomaly-based or machine-learning based IDS monitors network traffic and compares it against an established baseline. The baseline will identify what is “normal” for that network, such as what sort of bandwidth is generally used and what protocols are used. A stateful protocol analysis IDS identifies deviations of protocol states by comparing observed events with defined profiles of generally accepted definitions of benign activity. It will be appreciated that these detection methods are by way of example and not limitation. Other embodiments may use different detection methods as well. The embodiments are not limited in this respect.

FIG. 1B illustrates an example of a TSN node 104a of the TSN 102 designed to control one or more sensors 144. As depicted in FIG. 1B, the TSN node 104 manages various types of sensors 144, such as a signal sensor 116, a biometric sensor 118, a power sensor 120, an acoustic sensor 122, a sound sensor 124, a visual sensor 126, a speed sensor 128, a temperature sensor 130, and so forth. The TSN node 104a may be suitable for implementing a physics-based model for the IDS 110. A physics-based approach as proposed herein utilizes state prediction based on physical models of system dynamics. Unlike conventional information-based security measures, the physics-based model may utilize physical properties of a system, along with controller state estimation, to enable computationally-inexpensive analytical redundancy. For example, a mathematical model-based replica of the system is simultaneously executed to detect attacks.

FIG. 1C illustrates an example of a TSN node 104b of the TSN 102 designed to control one or more actuators and/or host controllers 146. As depicted in FIG. 1C, the TSN node 104b manages various types of actuators/controllers 146, such as a robotic controller 136, a server controller 138, a mechanical actuator 148, a circuit controller 140, a device controller 142, a video controller 132, a computer controller 134, and so forth. As with FIG. 1B, the TSN node 104b shown in FIG. 1C may be suitable for implementing a physics-based model for the IDS 110, as discussed in more detail herein.

In time-synchronized networks, such as the TSN 102 depicted in FIGS. 1A-1C, it becomes important for all the TSN nodes 104 to synchronize to a common or shared network time for the TSN 102. For instance, the TSN nodes 104 may operate in accordance with IEEE 802.1AS which implements a hierarchical network to synchronize one or more clock follower (CF) nodes to a clock leader (CL) node (e.g., a grand CL) through relay nodes or switch nodes. Synchronization is performed through communication of time messages, such as the messages 112. The time messages may comprise, for example, time synchronization messages, time update messages and/or time follow-up messages for a PTP.

In some cases, an attacker may simply attempt to disrupt timing of a single TSN node 104 handling critical functions, such as disrupting one or both of the TSN node 104a managing the sensors 144 and/or the TSN node 104b managing the actuators/controllers 146. Rather than attempting to disrupt timing for the entire TSN 102, the attacker may attempt to attack timing of a single TSN node 104 to disrupt key operations for the TSN node 104, such as an electronic control unit (ECU) to control speed sensing for a vehicle or a controller for a robotic arm in a factory.

In other cases, an attacker may attempt to disrupt timing across the entire TSN 102. To attack or disrupt the TSN 102, an attacker may attempt a timing attack or desynchronization attack to compromise timing for one or more of the TSN nodes 104 in the TSN 102. Assume the TSN node 104c operates as a clock leader (CL) in the TSN 102, and the TSN node 104d operates as a clock follower (CF) in the TSN 102. If an attacker located on a network device (e.g., switch or relay) modifies a critical attribute on a specific port, then all downstream nodes from that network device will suffer a desynchronization event. In this example, if the attacker successfully compromises the TSN node 104c, then the TSN node 104d is vulnerable to a timing attack in the form of receiving messages 112 from the TSN node 104c with erroneous time information. Therefore, it becomes important to detect and localize an attack as quickly as possible. Furthermore, upon detection, it becomes important for the TSN 102 to quickly isolate the compromised network device and thereby prevent the desynchronization attack from spreading to other downstream nodes.

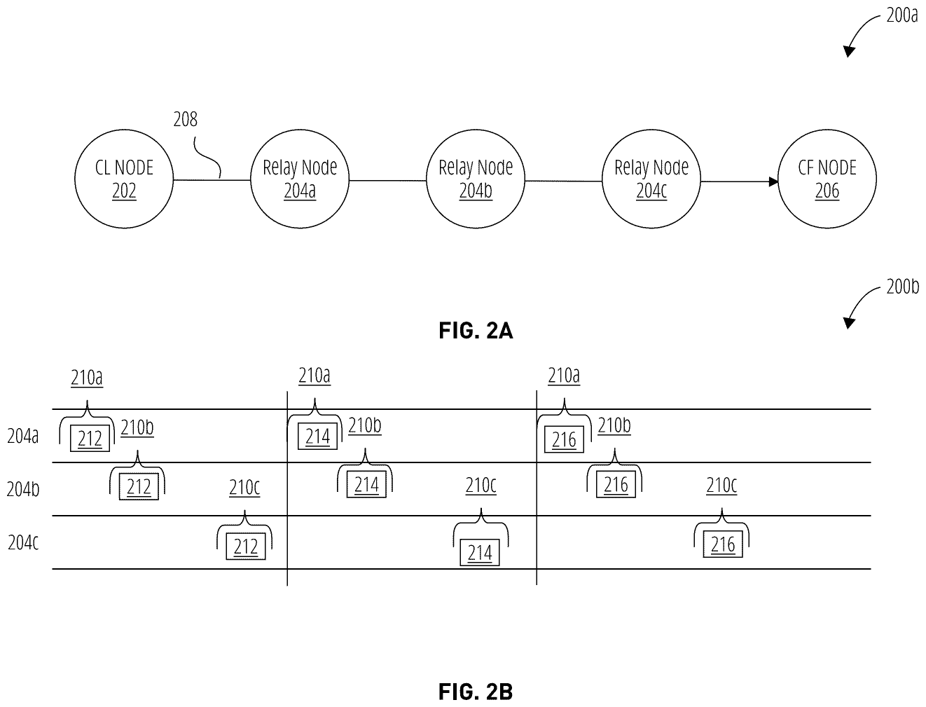

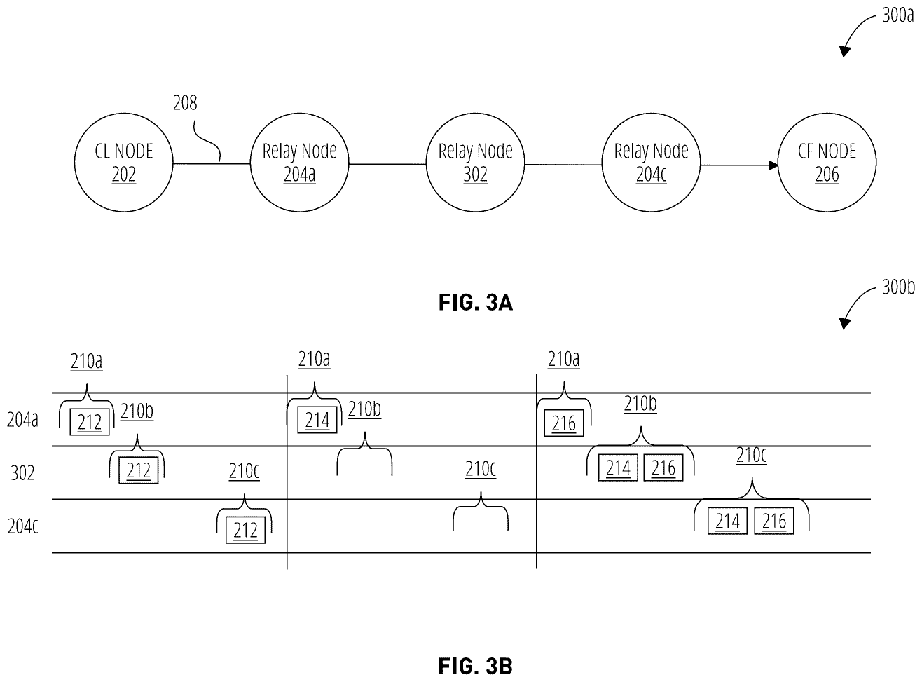

In all cases, a time-synchronized network such as the TSN 102 is vulnerable to a timing attack or a desynchronization attack. If a single network node is compromised, it may cause a cascade failure across the entire TSN 102. An example of such an attack is further described with reference to FIGS. 2A, 2B, 3A and 3B.

FIG. 2A depicts a TSN 200a implemented according to a TSN standard (e.g., IEEE 1588, IEEE 802.1AS, IEEE 802.1Qbv, or the like). As depicted, the TSN 200a includes clock leader node 202, relay nodes 204a, 204b, and 204c, and clock follower node 206, all communicatively coupled via communication channel 208. The clock leader node 202 and the clock follower node 206 have a “master/slave” relationship, where the clock leader node 202 is treated as a “master” device and the clock follower node 206 is treated as a “slave” device. The clock leader node 202 includes a clock that maintains a network time for the TSN 102. The clock follower node 206 includes a clock that synchronizes a clock to the network time via one or more of the messages 112. Alternatively, the clock leader node 202 and the clock follower node 206 may be implemented as a “talker node” and a “listener node”, respectively. This configuration refers to data transmission, where the talker node transmits data and the listener node listens or receives data. This configuration is used, for example, in scheduled traffic.

Relay nodes 204a, 204b, and 204c are time-aware switching nodes and can be any number of devices in a network arranged to communicate information. A clock leader node 202 sends or originates information and a clock follower node 206 receives or consumes information. Examples of a clock leader node 202 or a clock follower node 206 include devices such as electronic control units in an autonomous vehicle, an industrial system, a medical system, or the like. Additionally, communication channel 208 can be any of a variety of communication channels, including wired or wireless communication channels. In some implementations, all devices in the TSN 200a will receive GCL tables. However, in some implementations, only clock leader nodes 202 and switching nodes (e.g., relay node 204a, etc.) receive GCL tables while destination devices (e.g., clock follower node 206) do not receive a GCL table.

FIG. 2B depicts a timing diagram 200b depicting communication windows (e.g., Qbv windows, or the like) for switches of TSN 200a based on GCL tables. Typically, GCL tables are generated in a network controller (not shown) and are designed to prioritize time critical (TC) traffic and prevent lower priority traffic from accessing communication channel 208, thus guaranteeing the timely delivery of TC packets within pre-configured time windows. In particular, timing diagram 200b depicts Qbv windows 210a, 210b, and 210c in which packets 212, 214, and 216 are transmitted. It is noted that the communication windows referred to herein are referred to as Qbv windows or protected windows for clarity. However, other standard or techniques for forming protected communication windows to facilitate time synchronization can be used besides Qbv windows. Examples are not limited in this context.

To facilitate transmission of packets (e.g., packet 212, etc.) during protected windows (e.g., Qbv window 210a, etc.), nodes in the TSN 200a are time synchronized and scheduled to transmit TC packets (e.g., packet 212, etc.) using non overlapping protected windows (e.g., Qbv window 210a, etc.). It is to be appreciated that providing latency bounded communication (e.g., as depicted in timing diagram 200b) requires tight synchronization of time between nodes in TSN 200a. With such dependency on time synchronization, reliable TSN operation can be disrupted by attacking the timing of the network, sometimes referred to as a desynchronization attack or event.

FIG. 3A depicts a TSN 300a, which is like TSN 200a except that the relay node 302 is depicted as compromised. In particular, the clock (not shown) of relay node 302 can be attacked and compromised, thereby causing the Qbv window 210b associated with relay node 302 to be misaligned with respect to, and even overlap with, the protected windows of the other switch nodes in the data stream path (e.g., along communication channel 208).

FIG. 3B depicts timing diagram 300b illustrating Qbv window 210b misaligned with Qbv window 210a and Qbv window 210c and overlapping with Qbv window 210a. As such, packets (e.g., packet 214 in the figure) arrive too late with respect to the attacked switch protected window (e.g., Qbv window 210b) causing them to be buffered and sent in the next protected window. As a result of the delay in transmitting packet 214, relay node 302 breaks the latency bound of the stream that it is serving and can result in errors or comprise the safety of the system in which the nodes are operating

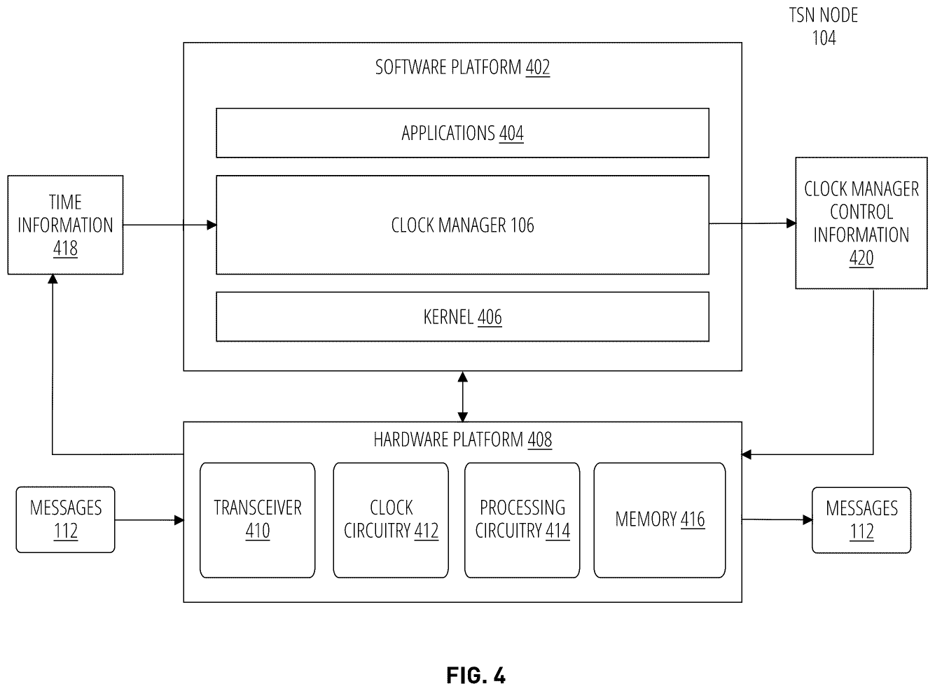

FIG. 4 illustrates a more detailed view of a TSN node 104 that implements one or more TSN protocols or standards. The TSN node 104 may be implemented as any network devices suitable for operation within a TSN, such as TSN 102, 200a, 300a, and so forth. The TSN node 104 may be implemented as part of a vehicle, robot, industrial machine or any other devices suitable for a TSN. The TSN node 104 may be implemented as an origination node 202, relay nodes 204a-204c, relay node 302 and/or end node 206. The TSN node 104 may be implemented as either a clock leader (CL) or a clock follower (CF) in a TSN. The TSN node 104 may include interfaces to communicate information with other TSN nodes 104 in the TSN 102, such as messages 112, for example.

The TSN node 104 may operate in accordance with a timing protocol, such as a precision time protocol (PTP) for IEEE 1588, IEEE 802.1AS, and so forth. For instance, the TSN node 104 may operate in accordance with IEEE 802.1AS which implements a hierarchical network to synchronize clock followers (CFs) to a clock leader (CL) through relays or switch nodes. Synchronization is performed through communication of time messages, such as the messages 112. The time messages may comprise, for example, time synchronization messages, time update messages or time follow-up messages (among others) for a PTP. The time messages may include, among other fields and attributes, a correction field, which accumulates a network residence, and an origin timestamp for a CL. The time message may also comprise, for example, a packet delay message type with additional fields and attributes.

As depicted in FIG. 4, the TSN device 104 may include a software platform 402 and a hardware platform 408. The software platform 402 may include, among other software components, one or more applications 404, a clock manager 106, and a kernel 406. The hardware platform 408 may include, among other hardware components, a network interface such as a transceiver 410, clock circuitry 412, processing circuitry 414 and memory 416.

The processing circuitry 414 may include circuitry or processor logic, such as, for example, any of a variety of commercial processors. In some examples, the processing circuitry 414 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processing circuitry 414 may include graphics processing portions and may include dedicated memory, multiple-threaded processing and/or some other parallel processing capability. In some examples, the processing circuitry 414 may be an application specific integrated circuit (ASIC) or a field programmable integrated circuit (FPGA). In some examples, the processing circuitry 414 may be circuitry arranged to perform computations related to TSN, such as switching, clock leader, clock follower, routing, security, and so forth.

The memory 416 may include logic, a portion of which includes arrays of integrated circuits, forming non-volatile memory to persistently store data or a combination of non-volatile memory and volatile memory. It is to be appreciated, that the memory 416 may be based on any of a variety of technologies. In particular, the arrays of integrated circuits included in memory 406 may be arranged to form one or more types of memory, such as, for example, dynamic random access memory (DRAM), NAND memory, NOR memory, or the like.

The transceiver 410 may include logic and/or features to support a communication interface. For example, the transceiver 410 may include one or more interfaces that operate according to various communication protocols or standards to communicate over direct or network communication links. Direct communications may occur via use of communication protocols or standards described in one or more industry standards (including progenies and variants). For example, the transceiver 410 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. In some examples, transceiver 410 may be arranged to support wireless communication protocols or standards, such as, for example, Wi-Fi, Bluetooth, ZigBee, LTE, 5G, or the like.

The TSN node 104 may also include where the network is a controller area network (CAN) or a vehicle area network (VAN). The TSN node 104 may be implemented as a device that manages a sensor, actuator or a controller. The sensors may comprise a speed sensor, a direction sensor, a global positioning system (GPS) sensor, a gas pedal sensor, a brake pedal sensor, a positioning sensor, an object detection sensor, a lane detection sensor, a radar sensor, a light detection and ranging (LIDAR) sensor, an ultrasound sensor, an inertial measurement unit (IMU) sensor, a temperature sensor, a pressure sensor, an altitude sensor, an acoustic sensor, and so forth.

In one aspect, the TSN node 104 may be implemented as a CL or CF for the TSN 102. As previously discussed, the clock manager 106 may ensure that the clock circuitry 412 maintains a network time for the TSN 102. When operating in a CL role, the clock manager 106 may send a message 112 with time information 418 representing a current network time to one or more nodes operating in a CF role for the TSN 102. When operating in a CF role, the clock manager 106 may receive a message 112 from a CL node. The clock manager 106 may use the time information 418 from the message 112 to synchronize a local device time with the current network time maintained by the clock circuitry 412. The clock manager 106 analyzes the time information 418, and determines whether to adjust a parameter (e.g., phase or frequency) of the clock circuitry 412 to synchronize the clock circuitry 412 to the current network time.

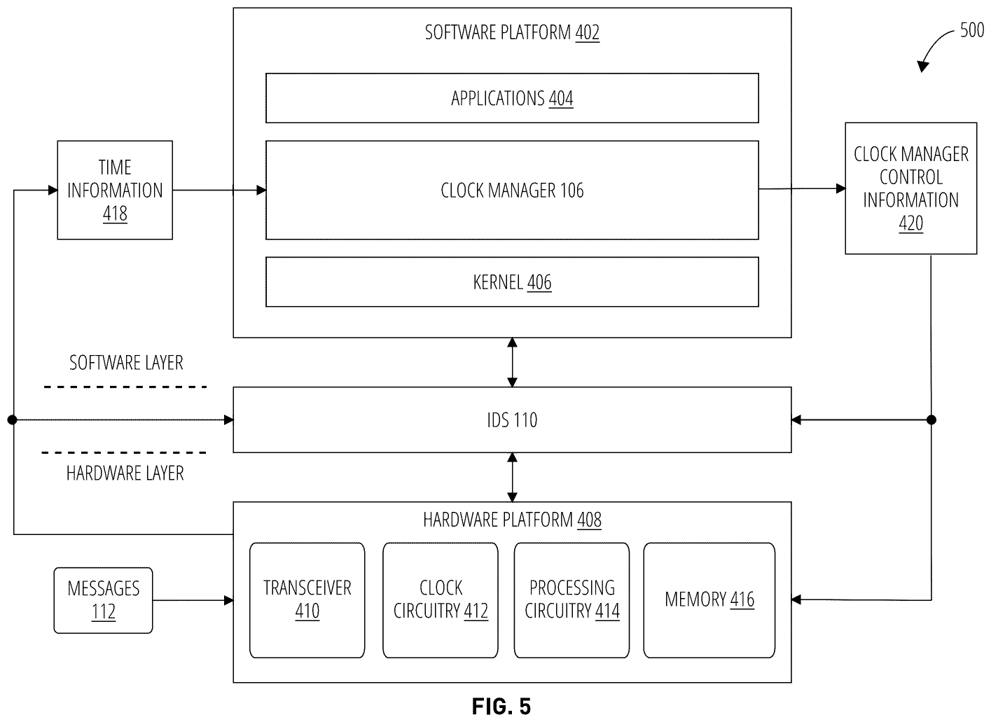

FIG. 5 illustrates an apparatus 500. Similar to the apparatus 400, the apparatus 500 includes a software platform 402 and a hardware platform 408. In addition, the apparatus 500 includes an IDS 110 to monitor a clock manager 106 of the software platform 402. As previously discussed, the IDS 110 generally monitors the clock manager 106 to detect abnormal or malicious behavior of the clock manager 106. More particularly, the IDS 110 monitors the inputs and/or outputs of the clock manager 106, such as consuming the time information 418 sent from the transceiver 410 to the clock manager 106 as input, and the clock manager control information 420 sent from the clock manager 106 to the clock circuitry 412 as output.

As depicted in FIG. 5, the apparatus 500 includes a clock circuitry 412 to implement a hardware clock (e.g., a PHC) for a device, such as a TSN node 104. The apparatus 500 includes a processing circuitry 414 coupled to the clock circuitry 412, the processing circuitry 414 to execute instructions to perform operations for a clock manager 106. The clock manager 106 is operative to receive messages 112 with time information 418 for a network, such as TSN 102. The clock manager 106 generates clock manager control information 420 to adjust the clock circuitry 412 to a network time for the TSN 102. The clock manager control information 420 may comprise one or more parameters to adjust the clock circuitry 412 for the apparatus 500. The one or more parameters may represent, for example, adjustments to a phase or frequency of the clock circuitry 412. For example, the clock manager control information 420 may comprise a phase or frequency adjustment based on a time offset between a reference time and a time maintained by the clock circuitry 412. The reference time is based on the time information 418 in at least one message 112.

The apparatus 500 further includes an IDS 110 coupled to the processing circuitry 414 and the clock circuitry 412. In one embodiment, the IDS 110 may be implemented as part of a software layer for the apparatus 500, such as the software platform 402. In another embodiment, the IDS 110 may be implemented as part of a hardware layer for the apparatus 500, such as the hardware platform 408. In yet another embodiment, certain elements of the IDS 110 may be implemented in the software platform 402, while other elements of the IDS 110 may be implemented in the hardware platform 408. Embodiments are not limited in this context.

Although FIG. 5 depicts the IDS 110 implemented as part of the apparatus 500, it may be appreciated that the IDS 110 may be implemented by another apparatus, device or system communicatively coupled to the apparatus 500. For instance, the IDS 110 may be implemented as part of an IDS for the apparatus 500 that is separate from the apparatus 500 or a device other than a device that implements the apparatus 500. For instance, if the apparatus 500 is implemented by a TSN node 104a, the IDS 110 of the apparatus 500 could optionally be implemented in a TSN node 104b. The IDS 110 could also be implemented by an IDS communicatively coupled to the TSN node 104, either directly via a wired or wireless connection, or indirectly via the TSN fabric 114. Embodiments are not limited in this context.

The IDS 110 is operative to consume multiple types of information to detect a security attack. For instance, the IDS 110 can receive and analyze messages 112 for a TSN node implementing the software platform 402 and/or the hardware platform 408. The messages 112 may carry time information for a TSN node, such as an origin time, resident time, link delays, among other types of clock information. The messages 112 may comprise, for example, synchronization messages or followup messages. The TSN node retrieves or decodes the time information from the messages 112, and utilize the time information to synchronize an internal local clock with a network time issued by a clock leader or grand clock leader. The IDS 110 can also receive and analyze other types of information, such as clock manager control information 420 in transit from the clock manager 106 of the software platform 402 and the hardware platform 408. For instance, the IDS 110 can consume software control messages, or it can have one or more taps on a hardware bus or signal lines used to communicate electrical signals to the hardware platform 408. The IDS 110 analyzes the messages 112 and/or other types of information, and determines whether to generate an alert or take corrective action for the apparatus 500 based on results of the analysis.

The messages 112 are communicated between TSN nodes at a certain frequency or rate which can be measured in a number of messages sent or received per unit of time, such as a number of messages sent per second. This is referred to herein as a “message frequency.” The message frequency for transmission of the messages 112, which carry origin time (Sync/FollowUp) and link delay computation (LDC), is typically dependent on the latency requirements of a time-sensitive application. The message frequency is usually calculated during a design phase for a TSN, considering a variety of factors, and instantiated during initialization of a TSN or individual TSN nodes.

Cybersecurity is increasingly becoming a critical or core function within a TSN. Numerous security devices, such as the IDS 110, are deployed throughout a TSN 102. Each deployed IDS 110 monitors a TSN node 104 or group of TSN nodes 104, receiving the messages 112 and analyzing the messages 112 for anomalies or abnormalities indicative of a security attack. Despite increasing security of a TSN, however, the multitude of IDS 110 also introduce slight time offset bias into the messages 112. Each scan by the IDS 110 adds a certain amount of latency or delay while the IDS 110 performs the scan, sometimes referred to as an “inspection time interval” or “inference delay interval.” While a given TSN protocol may attempt to account for various types of message delay throughout a network, such as a residence time delay incurred by a TSN node 104 or a path delay in a P2P protocol, the TSN protocols do not account for an inference delay of messages caused by security mechanisms, such as one or more IDS 110. As a number of IDS 110 deployed in a TSN 102 increases, so does an accumulated inference delay incurred by a message as it transits the TSN. This problem is exacerbated by an increase in a length for scanning times to account for an ever-growing attack surface for individual TSN nodes 104. The accumulated inference delay can itself cause TSN nodes 104 or TSN applications 404 to desynchronize, affecting performance or causing failures. Ironically, the additional security provided by an IDS 110 to prevent desynchronization attacks may in aggregate actually cause a desynchronization event itself.

For instance, the IDS 110 may introduce a time offset bias on the order of nanoseconds or microseconds per synchronization cycle. Clock drift in a TSN node 104, such as a clock follower node 206, may accumulate over time until it reaches a point where the TSN node 104 or a TSN application 404 consuming time from a clock 108 of the TSN node 104 destabilizes or fails. Meanwhile, the IDS 110 may be unaware that is actually causing lower levels of time offset bias, even if the IDS 110 is sensitive enough to detect the time offset bias. As a consequence, security performance by an IDS 110 may actually cause or contribute to a desynchronization event of a TSN node 104 in the TSN 102.

To solve these and other challenges in a TSN, embodiments implement techniques to consider time delays associated with security measures used by a TSN, such as inspection times or inference times for an IDS 110, for example. In some embodiments, an IDS 110 may measure an inspection time or inference time for a message 112 as it transits the IDS 110. The inspection time may include an amount of time representing a time interval between receiving a message 112 by an IDS 110 and sending the message from the IDS 110, including any processing time incurred by the message 112 in-between receipt and transmit. The IDS 110 may consider the measured inspection time in TSN timing operations. For instance, the measured inspection time may be added to the message 112, such as a correction value in a correction field of the message 112. Alternatively, the measured inspection time can be reported out-of-band from the message 112, such as through a central security server or direct path to a destination node (e.g., a clock follower node). In this manner, inspection times or inference times delaying messages 112 can be accounted for by a TSN node 104, TSN system 102, and/or TSN protocol.

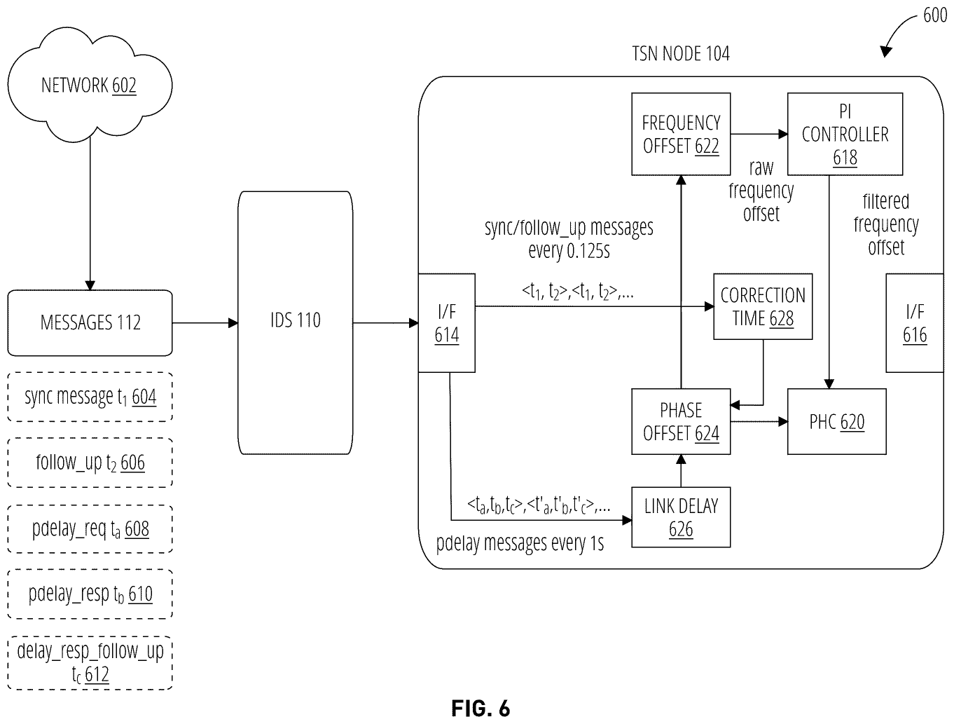

FIG. 6 illustrates a system 600. As depicted in system 600, a TSN node 104 may receive a number of messages 112 via a network 602, such as the TSN 102, for example. Prior to entering the TSN node 104, an IDS 110 may receive as input the messages 112 and performs a security scan for each message 112. Once the IDS 110 completes the security scan for one or more of the messages 112, it outputs the one or more scanned messages 112 to the TSN node 104 for normal processing by the TSN node 104. For purposes of this example, assume the TSN node 104 is a TSN node 104c operating as a relay node or switch node for the TSN 102.

In various embodiments, the messages 112 may communicate time information 418 for the TSN 102. When the TSN 102 implements PTP in accordance with IEEE 1588, for example, the messages 112 may comprise two PTP message types. The first PTP message type is event messages, which require accurate timestamps both at sending and receiving because PTP uses these as timing events, e.g., to carry time information 418. Event messages are used in the time synchronization process to transfer timestamps and correction information between master and slave. Examples of event messages may include Sync, Delay_Req, Pdelay_Req and Pdelay_resp. The second PTP message type is general messages, which are used to transmit information. In contrast to event messages, sending and receiving general messages does not produce a timestamp. Examples of general messages may include Announce, Follow Up, Delay_Resp, Pdelay_Resp_Follow_Up, Management and Signaling. It is worthy to note that the messages 112 carrying time information 418 may vary in accordance with a given TSN protocol. Embodiments are not limited in this context.

The IDS 110 may be designed to inspect one or both message types. The IDS 110 inspects messages 112 that carry time information 418 in order to detect timing attacks, such as a desynchronization attack, for example. System 600 depicts examples for five different PTP message sub-types, including a sync message t₁ 604, a follow_up t₂ 606, a Pdelay_req tₐ 608, a Pdelay_resp t_{b} 610, and a delay_resp_follow_up t_{c} 612. It may be appreciated that these are merely example message sub-types for the messages 112, and others may be used as well. Embodiments are not limited in this context.

In some embodiments, the IDS 110 scans and performs inferencing for a single message 112. In other embodiments, the IDS 110 scans multiple messages 112. Some key performance indicators (KPIs) may need calculations across multiple messages 112. For example, both sync and follow_up are needed to calculate a time offset, three pdelay messages are needed to calculate peer delay, and so forth.

Once the IDS 110 inspects a message 112, it passes the message 112 to the TSN node 104. As depicted in FIG. 6, the TSN node 104 may comprise an ingress interface 614 and an egress interface 616. The ingress interface 614 receives the messages 112, and processes the messages 112 according to a given message type. For instance, assume TSN node 104a operates as a clock leader node for the TSN 102. The TSN node 104a may send a sync message t₁ 604 and follow_up t₂ 606 every 0.125 seconds. The ingress interface 614 of the TSN node 104c may receive the sync message t₁ 604 and follow_up t₂ 606 in sequence, e.g., <t₁, t₂>, <t₁, t₂>, and so forth. The clock manager 106c may use time information 418 carried by the sync message t₁ 604 and/or the follow_up t₂ 606 to generate correction time 628 for the PHC 620. Similarly, the ingress interface 614 of the TSN node 104c may receive pdelay messages, such as pdelay_req tₐ 608, pdelay_resp t_{b} 610 and delay_resp_follow_up t_{c} 612, every 1 second, e.g., <tₐ, t_{b}, t_{c}>, <t′ₐ, t′_{b}, t′_{c}>, and so forth. The clock manager 106c may use the time information 418 carried by the pdelay messages to generate a link delay 626, which is also used to generate correction time 628 for the PHC 620.

The correction time 628 may include a phase offset 624 and/or a frequency offset 622. The phase offset 624 may be output to the PHC 620. The raw frequency offset 622 may be filtered by a PI controller 618, which outputs the filtered frequency offset 622 to the PHC 620. The PHC 620 uses the phase offset 624 and the frequency offset 622 to adjust a network time for the clock hardware. When implemented as a relay or switch, the TSN node 104c may output the messages 112 via the egress interface 616 to the next TSN node 104 in a network path through the TSN 102 to its ultimate destination.

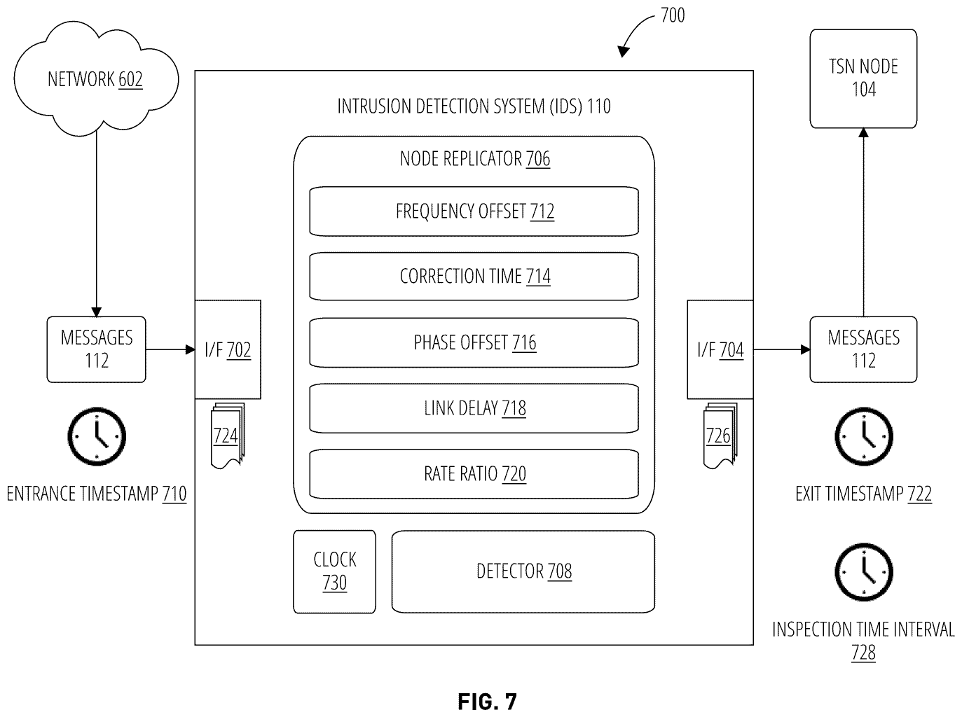

As previously discussed, prior to receiving a message 112 by the TSN node 104c, the IDS 110 inspects the message 112 to ensure it has not been compromised (e.g., carries incorrect or modified time information 418). While the IDS 110 increases security for the TSN 102, the inspection time caused by the IDS 110 creates two additional threat scenarios, depending on a particular implement. In a first case, the IDS 110 may pass the message 112 through to the clock follower before it completes inspection operations. While this may potentially reduce inspection delay, the clock follower may be impacted by erroneous time information 418 carried by the message 112 before the IDS 110 completes inspection operations and can take appropriate corrective actions for the message 112. In a second case, the IDS 110 may implement a store-and-forward technique, basically storing the message 112 until the IDS 110 completes inspection operations, and then forwarding the message 112 once the inspection operations are complete. While this case reduces or prevents the clock follower from consuming any erroneous time information 418 from the message 112, it introduces a maximum amount of inspection delay for the message 112. This may reduce a quality of the time synchronization process within the TSN 102. In both scenarios, particularly the latter scenario, the inspection time of the IDS 110 should be considered in the time synchronization process for the TSN 102. A novel IDS 110, and techniques to account for associated time delay caused by the IDS 110, are discussed with reference to FIG. 7.

FIG. 7 illustrates a system 700 with a more detailed view of an IDS 110. The IDS 110 may be implemented as shown in system 600, where the IDS 110 is placed on an egress port of the TSN node 104c, and inspects messages 112 transported by the network 602 before the messages 112 are received and processed by the TSN node 104c. Further, the IDS 110 implements the second case, where the IDS 110 implements a store-and-forward technique for the messages 112. In this way, impact to the TSN node 104c from erroneous time information 418 carried by a compromised message 112 should be reduced, since the IDS 110 will have time to inspect each message 112, detect any abnormalities in time information 418 carried by the messages 112, and either drop or correct the messages 112 if compromised and carrying erroneous time information 418 modified by an attacker in an upstream network path of the TSN 104c. This type of implementation optimizes safety operations for the TSN node 104c. However, it introduces a maximum amount of inspection delay for the messages 112.

Consequently, the IDS 110 implements various techniques to measure the inspection delay, and compensate for the measured inspection delay in the time synchronization process of the TSN 102.

In one embodiment, for example, the IDS 110 may implemented by a computing apparatus that includes a processor circuitry. The computing apparatus also includes a memory communicatively coupled to the processor circuitry, the memory storing instructions that, when executed by the processor circuitry, cause the processor circuitry to receive a message 112 with time information 418 at an ingress queue 724 for an ingress interface 702 of the IDS 110. The IDS 110 may monitor a network node of a TSN 102, such as a TSN node 104. The time information 418 may comprise information to synchronize a first clock 108a for a clock leader node (e.g., a TSN node 104a) and a second clock 108b for clock follower node (e.g., a TSN node 104b) to a network time for the TSN 102 maintained by the first clock 108a. The IDS 110 may generate an entrance timestamp 710 for the message 112, the entrance timestamp 710 to comprise a time value representing when the message 112 is received at the ingress queue 724 of the ingress interface 702 of the IDS 110. The IDS 110 may inspect the message 112 for indications of a security attack on the time information 418 of the message 112. The IDS 110 may generate an exit timestamp 722 for the message 112, the exit timestamp 722 to comprise a time value representing when the message 112 is received at an egress queue 726 of an egress interface 704 of the IDS 110. The IDS 110 may generate an inspection time interval 728 associated with the IDS 110, the inspection time interval 728 to represent a time interval between the entrance timestamp 710 and the exit timestamp 722 for the message 112 while transiting or traversing the IDS 110.

In general, the IDS 110 measures an inspection delay for a message 112 as it traverses the IDS 110. The measured inspection delay is a time interval that spans a time the IDS 110 receives the message 112, processes the message 112 during inspection operations, and sends the message 112 to the TSN node 104c. For instance, as depicted in FIG. 7, an IDS 110 may receive messages 112 from the network 602 at an ingress interface 702. The IDS 110 may store the received messages 112 in an ingress queue 724 during inspection operations for the received messages 112. Prior to inspecting a received message 112, the IDS 110 timestamps the received message 112 with an entrance timestamp 710 generated from a clock 730. In one embodiment, for example, the clock 730 may comprise a monotonic clock. The entrance timestamp 710 is a value that represents a start time when the message 112 is received by the IDS 110. The IDS 110 than initiates inspection operations for the message 112. After the IDS 110 completes inspection operations for the received message 112, and determines the received message 112 is not compromised (e.g., carries correct time information 418), the IDS 110 stores the inspected message 112 to the egress queue 726 of an egress interface 704 for forwarding to the TSN node 104c. The IDS 110 timestamps the received message 112 with an exit timestamp 722 from the monotonic clock. The exit timestamp 722 is a value that represents an end time when the message 112 is sent from the IDS 110. The IDS 110 then forwards the message 112 to the TSN node 104 it is monitoring.

The IDS 110 generates the entrance timestamp 710 for the message 112 using a start value of a monotonic clock 730 and the exit timestamp 722 for the message using an end value of the monotonic clock 730. The IDS 110 can use the entrance timestamp 710 and the exit timestamp 722 to calculate an inspection time interval 728. The inspection time interval 728 is a time interval between the entrance timestamp 710 and the exit timestamp 722. The inspection time interval 728 represents a total amount of time delay associated with inspection or inference operations for the message 112 by the IDS 110. The IDS 110 may add the inspection time interval 728 to a correction field for the message 112 prior to forwarding the message 112 to the TSN node 104. In one embodiment, the correction field may be an existing correction field for a TSN protocol, such as a correction field used for correcting residence time of a TSN node 104. In one embodiment, the correction field may be a new correction field for a TSN protocol, such as a correction field dedicated for carrying security parameters for the message 112. Embodiments are not limited in this context.

During inspection operations, the IDS 110 may implement a detector 708 to detect whether the time information 418 for a message 112 has been tampered with, modified or otherwise corrupted by a security attack. The detector 708 may utilize any of the previously described inspection techniques to detect abnormalities in the time information 418 of a message 112.

In addition, the detector 708 may perform inspection operations utilizing one or more key performance indicators (KPIs) typically performed by the TSN node 104. The IDS 110 may calculate one or more KPIs from within the IDS 110 for the TSN node 104. For instance, the IDS 110 may calculate multiple KPIs from within the IDS 110 for the TSN node 104, where the KPIs comprise a frequency offset KPI, a correction time KPI, a phase offset KPI, a link delay KPI, or a rate ratio KPI. It may be appreciated that other KPIs may be generated as well, and the embodiments are not limited in this context.

As described with reference to FIG. 6, the system 600 illustrates the TSN node 104 performing certain operations, such as generating a correction time 628, a phase offset 624, a frequency offset 622, and a link delay 626 to update or synchronize the PHC 620 with a network time for the TSN 102. The information generated for these operations may also be useful in determining whether the time information 418 for a message 112 has been compromised. Rather than receiving this information from the TSN node 104, such as through a delayed feedback loop, the IDS 110 may implement mathematical models for each of these operations in the IDS 110.

As depicted in FIG. 7, the IDS 110 may include a node replicator 706. The node replicator 706 may include one or more mathematical models to simulate one or more time synchronization operations performed by the TSN node 104. For instance, the node replicator 706 may include mathematical models to generate a frequency offset 712, a correction time 714, a phase offset 716, a link delay 718, and a rate ratio 720. The node replicator 706 may retrieve a message 112 stored in the egress queue 726, retrieve time information 418 from the message 112, and use the mathematical models to generate one or more parameters from the time information 418 that simulate corresponding one or more parameters generated by the TSN node 104. The node replicator 706 may output these parameters to the detector 708. The detector 708 may analyze the one or more parameters to detect differences with expected values (e.g., residual values), and determine whether the time information 418 has been compromised based on the differences.

In various embodiments, the node replicator 706 may use one or more mathematical models derived from a physics-based model of one or more features or properties of the time synchronization process used by the TSN 102. The physics-aware model instantiated or represented by the node replicator 706 may incorporate modeling strategies to unlock monitoring of dynamical behavior of the time-synchronization process. The physics-aware model captures behavioral aspects of a TSN 102 whose outputs depends on inputs over time, e.g., a stateful process. The behavioral data is then translated into model attributes in order to obtain accurate predictions or estimates of various phases of the time-synchronization process.

The physics-aware model is based on benign input/output data capturing various responses within a TSN 102 based on excitations by capturing key dynamical responses features. An example response may include follower-to-leader time offset values for messages communicated within the TSN 102. An example of excitation may include clock adjustments, such as frequency or phase adjustments, made for a clock maintained by a clock follower node. The node replicator 706 may implement the physics-aware model, which may receive as input time information 418, generate estimated time values for one or more messages 112, and output the estimated time values. The estimated time values may be compared with actual time values to produce difference information, e.g., a residual signal. The detector 708 may analyze the residual signal based on a set of thresholds, generate an alert when the thresholds are met or exceeded, and take corrective actions in response to the alert. In some embodiments, for example, an IDS 110 can use the physics-aware model to detect attacks introducing a time bias on the order of hundreds of nanoseconds per synchronization cycle.

The detector 708 may analyze the one or more parameters received from the node replicator 706 to detect differences with expected values (e.g., residual values), and determine whether the time information 418 has been compromised based on the differences. For example, assume the detector 708 examines pdelay messages such as the pdelay_req tₐ 608, the pdelay_resp t_{b} 610 and the delay_resp_follow_up t_{c} 612. Further assume the detector 708 detects one or more delay_resp_follow_up to 612 as malicious. The detection will trigger a mitigation response to drop the delay_resp_follow_up to 612 from the egress queue 726 of the egress interface 704. Dropping delay_resp_follow_up t_{c} 612 messages will cause the link delay calculation to fail and thus the clock follower to naturally drift away from the clock leader due to imperfections in the clock oscillator. If the attack is persistent causing consecutive sync intervals to fail, a new clock leader is chosen as per protocol. In another example, assume the detector 708 detects one or more pdelay_resp t_{b} 610 messages as malicious. Dropping pdelay_resp t_{b} 610 messages will cause the sync to fail and thus the clock follower to naturally drift away from the clock leader due to imperfections in the clock oscillator. If the attack is persistent causing consecutive sync intervals to fail, a new clock leader is chosen as per protocol.

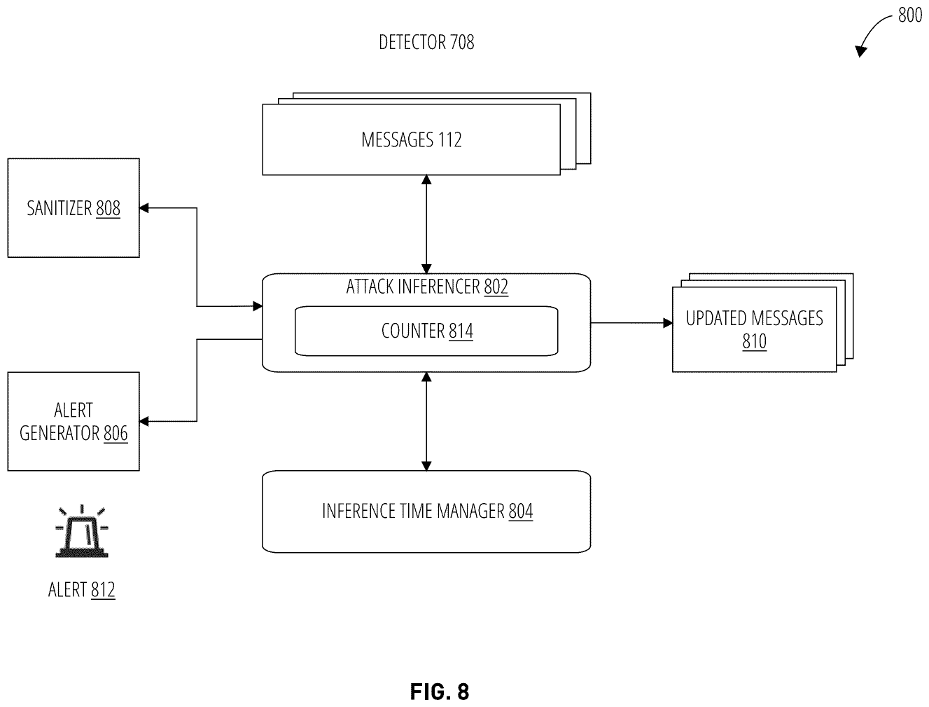

FIG. 8 illustrates a system 800. The system 800 depicts components and information for the detector 708 used by the IDS 110.

As depicted in FIG. 8, the detector 708 may include an attack inferencer 802. The attack inferencer 802 may receive one or more messages 112 from the network 602. The messages 112 may comprise, for example, a synchronization message, a follow up message, a pdelay request message, a pdelay response message, a delay response follow up message, delay mechanism messages, network-delay measurement mechanism messages, peer delay messages, path delay messages, network delay messages, end-to-end (E2E) messages, peer-to-peer (P2P) messages, and other TSN message types or sub-types. The attack inferencer 802 may determine whether the message 112 is a benign message or a malicious message based on the inspection of the message 112, and take various types of actions in accordance with the determination.

The detector 708 may also include an inference time manager 804. The inference time manager 804 may manage the inspection time interval 728 for a message 112. When the attack inferencer 802 determines that a message 112 is a benign message, it informs the inference time manager 804. The inference time manager 804 may update a correction value within a correction field for the message 112 with the inspection time interval 728 based on the inspection results for the message 112. The attack inferencer 802 may then forward or send the message 112 as an updated message 810, where the updated message 810 may include an updated correction value, from the egress queue 726 of the egress interface 704 of the IDS 110 to the TSN node 104.

When the attack inferencer 802 determines the message 112 is a malicious message based on the inspection of the message 112, it may take one of several different actions, including active filtering or passive filter. Active filtering includes dropping or attempting to sanitize malicious messages 112 on a per message basis as they are detected. Passive filtering includes monitoring malicious messages 112 over multiple synchronization cycles and waiting to trigger corrective actions if an abnormal trend is detected, such as a steady or increasing time offset bias over N synchronization intervals. The attack inferencer 802 may also use a combination of active filtering and passive filtering, such as attempting to correct malicious messages 112 (rather than dropping them) while monitoring message flow to detect an abnormal trend over time.

As an example of active filtering, if the message 112 is automatically stored in the egress queue 726 of the egress interface 704 waiting for an inspection result from the attack inferencer 802, the attack inferencer 802 may send a control signal to drop the message 112 from the egress queue 726 of the egress interface 704 so that the message 112 is not sent from the egress interface 704 of the egress interface 704 of the IDS 110 to the TSN node 104. If the message 112 is not automatically stored in the egress queue 726 of the egress interface 704, the attack inferencer 802 may send a control signal to drop the message 112 from the ingress queue 724 of the ingress interface 702 (or some other memory structure such as a temporary buffer). In either case, the attack inferencer 802 disposes of malicious messages before they ever arrive at the TSN node 104.

As another example of active filtering, when the attack inferencer 802 determines that the message 112 is a malicious message based on the inspection of the message 112, it may attempt to correct or sanitize the malicious message to recover original time information 418. The attack inferencer 802 may send a control signal to a sanitizer 808. The sanitizer 808 may attempt to sanitize or correct the malicious message to transform it from a malicious message to a benign message or a corrected message, e.g., from a message with erroneous time information 418 to a message with correct time information 418. In other words, the sanitizer 808 attempts to remove any detected time offset bias from the time information 418. The benign message (or corrected message) may then be sent to the inference time manager 804 to update a correction value within a correction field for the benign message with the inspection time interval 728. The attack inferencer 802 may then send the benign message (or corrected message) with the updated correction value from the egress queue 726 of the egress interface 704 of the IDS 110 to the TSN node 104.

As an example of passive filtering, the attack inferencer 802 may determine that a message 112 is a malicious message based on the inspection of the message 112. The attack inferencer 802 may increment a counter 814 with a count of messages or a count of synchronization cycles associated with a current number of previously received malicious messages 112. The attack inferencer 802 may compare the current count of messages and/or synchronization cycles to a defined threshold value, and generate an alarm when the count of messages and/or synchronization cycles is greater than or equal to the defined threshold value.

When the attack inferencer 802 determines that the message 112 is a malicious message in active filtering or when a current count is greater than or equal to a defined threshold in passive filtering (or both), it may send a control signal to an alert generator 806. The alert generator 806 may generate an alert 812 in response to the control signal. The IDS 110, or other devices within the TSN 102, may take corrective actions in response to the alert 812, such as attempting to identify and isolate a source of the security attack within the TSN 102.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

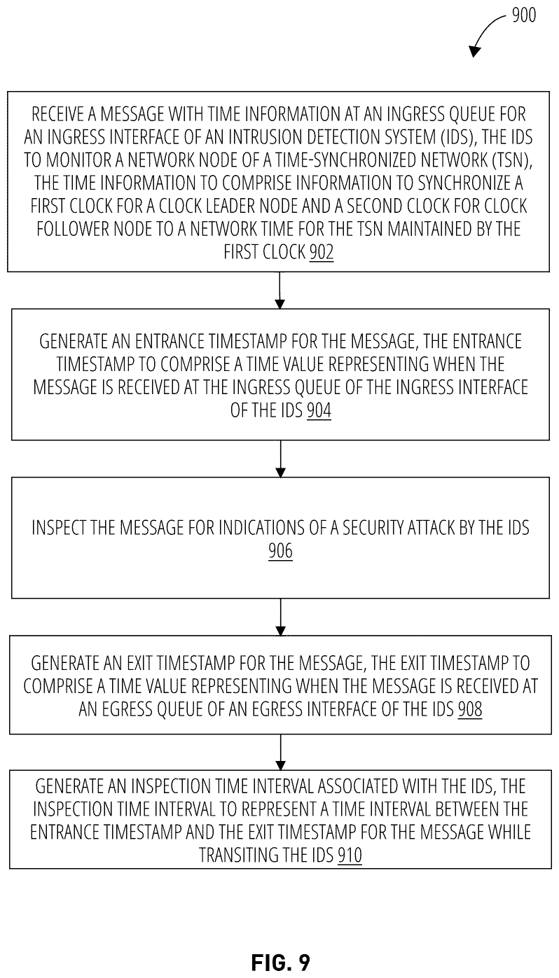

FIG. 9 illustrates an embodiment of a logic flow 900. The logic flow 900 may be representative of some or all of the operations executed by one or more embodiments described herein. For example, the logic flow 900 may include some or all of the operations performed by devices or entities within the TSNs 102, 200 or 300, the TSN node 104, the IDS 110, the apparatus 500, as well as the system 600, the system 700 or the system 800. More particularly, the logic flow 900 illustrates a use case where the IDS 110 measures an inspection time interval 728 representing an amount of time the IDS 110 takes to inspect messages 112 in order to detect a desynchronization attack on one or more TSN nodes 104 of the TSN 102.

Embodiments are not limited in this context.

In block 902, the logic flow 900 may receive a message with time information at an ingress queue for an ingress interface of an intrusion detection system (IDS), the IDS to monitor a network node of a time-synchronized network (TSN), the time information to comprise information to synchronize a first clock for a clock leader node and a second clock for clock follower node to a network time for the TSN maintained by the first clock. For example, the IDS 110 may receive a message 112 with time information 418 at an ingress queue 724 for an ingress interface 702 of the IDS 110. The IDS 110 may monitor a network node of a TSN 102, such as a TSN node 104. The time information 418 may comprise information to synchronize a first clock 108a for a clock leader node (e.g., TSN node 104a) and a second clock 108b for a clock follower node (e.g., TSN node 104b) to a network time for the TSN 102 maintained by the first clock 108a.

In block 904, the logic flow 900 may generate an entrance timestamp for the message, the entrance timestamp to comprise a time value representing when the message is received at the ingress queue of the ingress interface of the IDS. For example, the IDS 110 may generate an entrance timestamp 710 for the message 112, the entrance timestamp 710 to comprise a time value representing when the message 112 is received at the ingress queue 724 of the ingress interface 702 of the IDS 110.

In block 906, the logic flow 900 may inspect the message for indications of a security attack by the IDS. For example, the IDS 110 may inspect the message 112 for indications of a security attack by the detector 708 of the IDS 110.

In block 908, the logic flow 900 may generate an exit timestamp for the message, the exit timestamp to comprise a time value representing when the message is received at an egress queue of an egress interface of the IDS. For example, the IDS 110 may generate an exit timestamp 722 for the message 112, the exit timestamp 722 to comprise a time value representing when the message 112 is received at an egress queue 726 of an egress interface 704 of the IDS 110.

In block 910, the logic flow 900 may generate an inspection time interval associated with the IDS, the inspection time interval to represent a time interval between the entrance timestamp and the exit timestamp for the message while transiting the IDS. For example, the IDS 110 may generate an inspection time interval 728 associated with the IDS 110, the inspection time interval 728 to represent a time interval between the entrance timestamp 710 and the exit timestamp 722 for the message 112 while transiting the IDS 110.

The logic flow 900 may optionally include one or more additional operations. For example, the logic flow 900 may also include where the message is implemented as a synchronization message, a follow up message, a pdelay request message, a pdelay response message, a delay response follow up message, delay mechanism messages, network-delay measurement mechanism messages, peer delay messages, path delay messages, network delay messages, end-to-end (E2E) messages, peer-to-peer (P2P) messages, or other message types or sub-types defined by a given TSN protocol.

The logic flow 900 may also include generating the entrance timestamp for the message using a start value of a monotonic clock and the exit timestamp for the message using an end value of the monotonic clock.

The logic flow 900 may also include calculating one or more key performance indicators from within the IDS for the network node.

The logic flow 900 may also include calculating multiple key performance indicators from within the IDS for the network node, the key performance indicators to comprise a frequency offset key performance indicator (KPI), a correction time KPI, a phase offset KPI, a link delay KPI, or a rate ratio KPI.

The logic flow 900 may also include determining whether the message is a benign message or a malicious message based on the inspection of the message.

The logic flow 900 may also include updating a correction value within a correction field for the message with the inspection time interval based on the inspection of the message.

The logic flow 900 may also include determining the message is a benign message based on the inspection of the message, updating a correction value within a correction field for the message with the inspection time interval, and sending the message with the updated correction value from the egress queue of the egress interface of the IDS to the network node.

The logic flow 900 may also include determining the message is a malicious message based on the inspection of the message, and dropping the message from the egress queue of the egress interface so that the message is not sent from the egress interface of the egress interface of the IDS to the network node.

The logic flow 900 may also include determining the message is a malicious message based on the inspection of the message, correcting the malicious message to a benign message, updating a correction value within a correction field for the benign message with the inspection time interval, and sending the benign message with the updated correction value from the egress queue of the egress interface of the IDS to the network node.

The logic flow 900 may also include where the IDS monitors an ingress port of the network node of the TSN.

The logic flow 900 may also include where the IDS monitors an egress port of the network node of the TSN.

The logic flow 900 may also include where the IDS monitors both an ingress port and an egress port of the network node of the TSN.

The logic flow 900 may also include generating an inspection report by the IDS, the inspection report to comprise inspection information for one or more messages inspected by the IDS, and sending the inspection report from the IDS to a global monitoring system for the TSN.

The logic flow 900 may also include determining the message is a malicious message based on the inspection of the message, incrementing a count of synchronization cycles associated with a current number of previously received malicious messages, comparing the count of synchronization cycles to a defined threshold value, and generating an alarm when the count of synchronization cycles is greater than or equal to the defined threshold value.

The logic flow 900 may also include determining a link delay value associated with the message, and sending the link delay value to a global monitoring system for the TSN.

The logic flow 900 may also include determining a residence time value associated with the message, and sending the residence time value to a global monitoring system for the TSN.

The logic flow 900 may also include determining an origin time value associated with the message, and sending the origin time value to a global monitoring system for the TSN. Other technical features may be readily apparent to one skilled in the art from the following figures, descriptions, and claims.

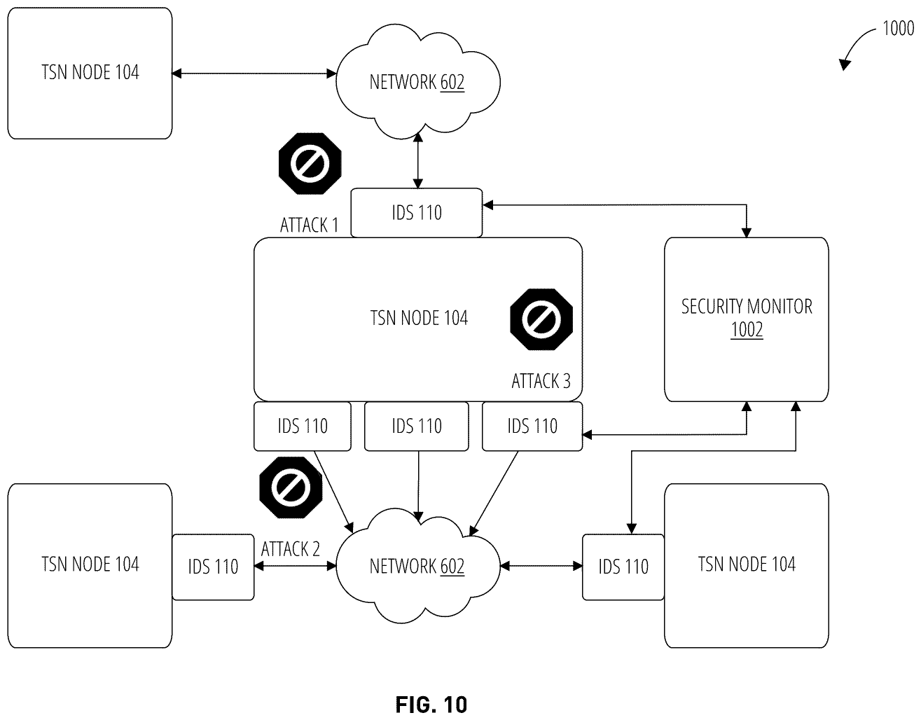

FIG. 10 illustrates an example of a system 1000 for implementing one or more IDS 110 in the TSN 102 to detect attacks within the TSN 102. Examples of attacks may include those attacks made external to the TSN node 104, such as a timing attack, a desynchronization attack, and other types of attacks to other TSN nodes 104 in the TSN 102, such as relay nodes, switch nodes, clock leader nodes, and so forth. Examples of attacks may also include internal attacks to a TSN node 104, such as by malware affecting software components of the software platform 402, such as the clock manager 106, for example. The attacks may be made on any TSN device type. For example, in a PTP network, the attacks may be made on five PTP device types, including ordinary clocks, boundary clocks, end-to-end transparent clocks, peer-to-peer transparent clocks, and management nodes.

The system 1000 illustrates the TSN 102 with multiple IDS 110 deployed throughout the TSN 102 to protect against attacks to TSN nodes implemented as device types with boundary clocks and ordinary clocks, for example. A TSN node 104 may have an IDS 110 that monitors an ingress port of the TSN node 104, an IDS 110 that monitors an egress port of the TSN node 104, or multiple IDS 110 to each monitor an ingress port and an egress port of the TSN node 104. Embodiments are not limited in this context.

To ensure complete security protection for a TSN node 104, the TSN node 104 should have an IDS 110 deployed for each ingress interface 614 and egress interface 616 for the TSN node 104. This ensures that the TSN node 104 is protected from external attacks and internal attacks, as demonstrated with attack points shown as attack 1, attack 2 and attack 3. For instance, an IDS 110 for the ingress interface 614 may stop invalid sync message t₁ 604 and follow_up t₂ 606 messages (e.g., with invalid reference times) at an ingress point for the TSN node 104. An IDS 110 for the egress interface 616 may stop invalid sync message t₁ 604 and follow_up t₂ 606 messages (e.g., with invalid resident times) at an egress point for the TSN node 104.

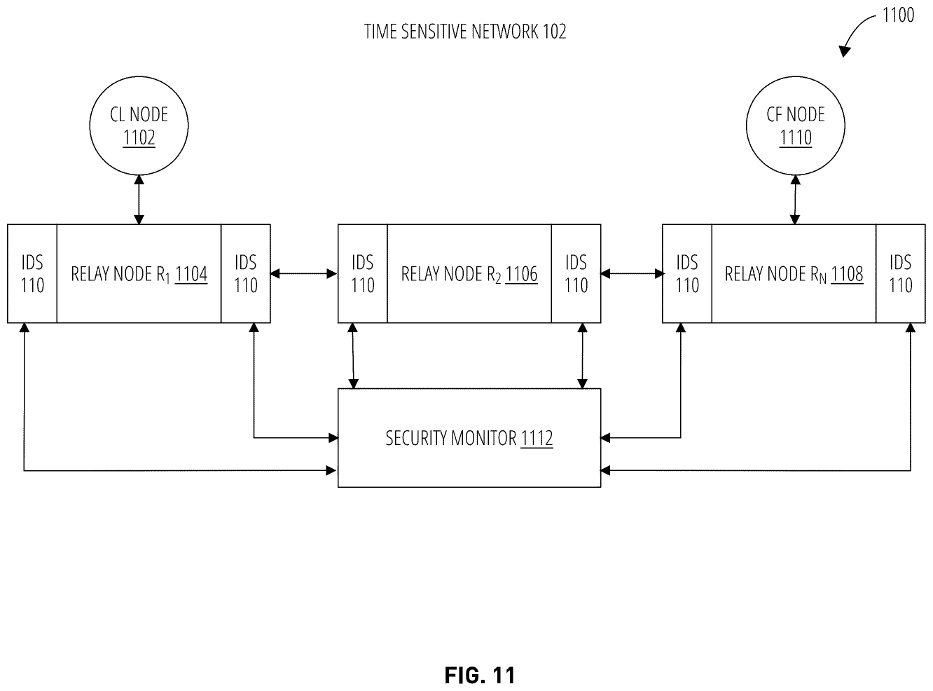

Each of the IDS 110 may report to a security monitor 1002 for global inferencing of attacks throughout the TSN 102. For example, each IDS 110 may generate an inspection report, where the inspection report comprises inspection information for one or more messages 112 inspected by the IDS 110. Each IDS 110 may send the inspection reports to a global monitoring system for the TSN 102, such as the security monitor 1002. Each IDS 110 may send the inspection reports on a periodic, aperiodic or on-demand basis. An example implementation for the security monitor 1002 will be discussed in more detail with reference to FIG. 11.

FIG. 11 illustrates a system 1100 with a security monitor 1002 to monitor multiple TSN nodes 104 in the TSN 102. The security monitor 1002 operates as a global monitoring system for the TSN 102. In one embodiment, for example, the security monitor 1002 may be implemented as a SIEM for the TSN 102.

The security monitor 1002 receives and collects inspection reports from the various IDS 110 monitoring various TSN nodes 104 of the TSN 102. As depicted in FIG. 11, for example, assume the TSN 102 includes multiple TSN nodes 104, such as a clock leader CL node 1102, a relay node R₁ 1104, a relay node R₂ 1106 and so forth through a relay node Rn 1108, and a CF node 1110. Each of the relay nodes may include an IDS 110 deployed on an ingress interface 702 and an egress interface 704.

Each of the IDS 110 may report to a security monitor 1002 for global inferencing of attacks throughout the TSN 102. For example, each IDS 110 may generate an inspection report, where the inspection report comprises inspection information for one or more messages 112 inspected by the IDS 110. Each IDS 110 may send the inspection reports to a global monitoring system for the TSN 102, such as the security monitor 1002. Each IDS 110 may send the inspection reports on a periodic, aperiodic or on-demand basis.

The security monitor 1002 may perform global monitoring for the TSN 102. Since it receives inspection reports from all the IDS 110 deployed throughout the TSN 102, it can perform global inferencing based on coalesced information from different parts of the TSN 102. For instance, the security monitor 1002 can perform global inferencing based on global link delay values, global resident time values, global origin time values, and other inferencing parameters associated with security attacks on TSN nodes 104 or a TSN network such as TSN 102.

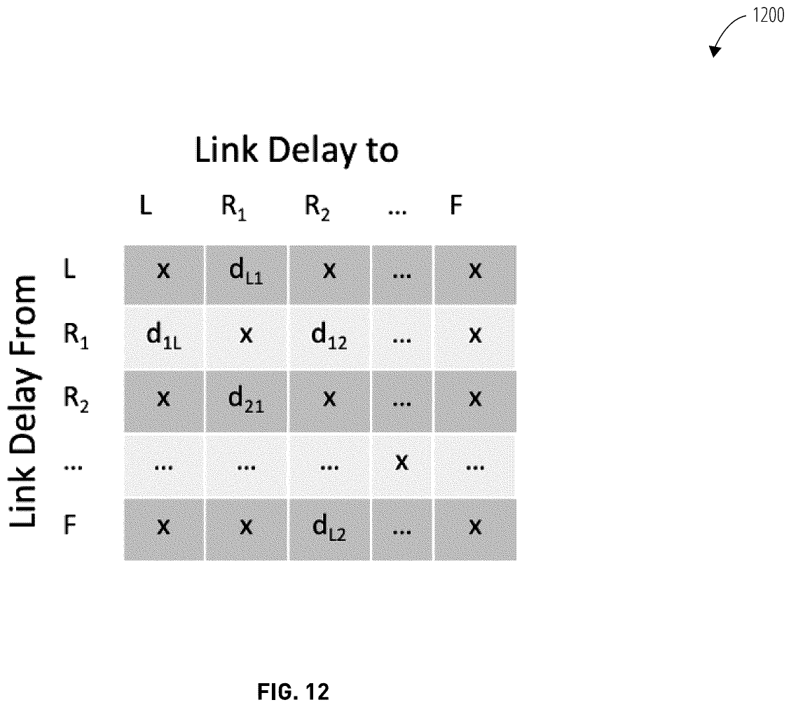

FIG. 12 illustrates a matrix 1200. The matrix 1200 may comprise an example of a link delay adjacency matrix for monitoring attacks on link delay information propagated throughout the TSN 102. As depicted in matrix 1200, the matrix 1200 may comprise rows and columns associated with each TSN node 104 for the TSN 102, including the CL node 1102, the relay node R₁ 1104, the relay node R₂ 1106, the relay node Rn 1108, and the CF node 1110. Each cell of the matrix 1200 may include link delay values from the TSN nodes 104 and link delay values to the TSN nodes 104.

Each of the IDS 110 may report to a security monitor 1002 for global inferencing of attacks throughout the TSN 102. For example, each IDS 110 may generate an inspection report, where the inspection report comprises inspection information for one or more messages 112 inspected by the IDS 110. In one embodiment, the inspection information may comprise link delay values. Each IDS 110 may determine a link delay value associated with a message 112, and send the link delay value to a global monitoring system for the TSN, such as the security monitor 1002. Link delays are expected to be symmetrical and consistent. Each link and link direction is calculated periodically and asynchronously. The matrix 1200 is updated when pdelay messages are exchanged, as reflected in the inspection reports from the IDS 110. If the delays are not symmetrical or the link delay values do not match the expectation, the security monitor 1002 may trigger an alarm and identify which of the relay nodes are at fault.

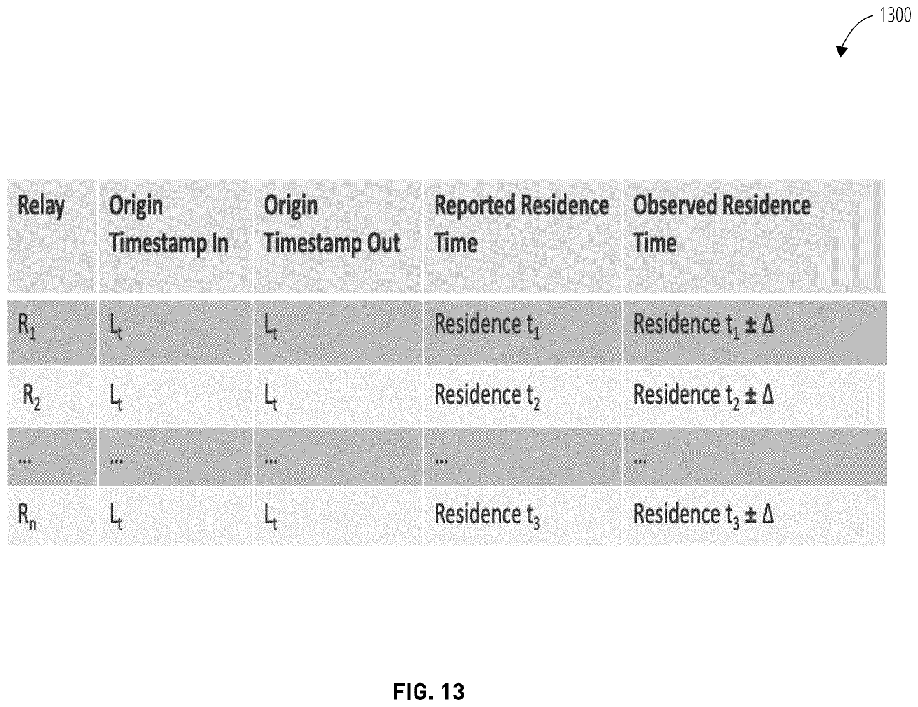

FIG. 13 illustrates a matrix 1300. The matrix 1300 may comprise an example of a resident time monitoring matrix and/or an origin timestamp monitoring matrix for monitoring attacks on residence time information and/or origin time information propagated throughout the TSN 102. As depicted in matrix 1300, the matrix 1300 may comprise rows associated with each TSN node 104 for the TSN 102, including the CL node 1102, the relay node R₁ 1104, the relay node R₂ 1106, the relay node Rn 1108, and the CF node 1110. The matrix 1300 may include columns with an origin timestamp in, an origin timestamp out, a reported residence time, and an observed residence time. Each cell of the matrix 1300 may include origin time values or residence time values from the TSN nodes 104.

In one embodiment, the matrix 1300 may comprise an example of a resident time monitoring matrix for monitoring attacks on residence time information propagated throughout the TSN 102. Each of the IDS 110 may report to a security monitor 1002 for global inferencing of attacks throughout the TSN 102. For example, each IDS 110 may generate an inspection report, where the inspection report comprises inspection information for one or more messages 112 inspected by the IDS 110. In one embodiment, the inspection information may comprise residence time values. The security monitor 1002 may update the matrix 1300 with the collected residence time values from the inspection reports. If the residence time that is reported does match an expected residence time, then the security monitor 1002 may trigger an alarm and identify which of the relay nodes modified the correction field.

In one embodiment, the matrix 1300 may comprise an example of an origin timestamp monitoring matrix for monitoring attacks on origin time information propagated throughout the TSN 102. Each of the IDS 110 may report to a security monitor 1002 for global inferencing of attacks throughout the TSN 102. For example, each IDS 110 may generate an inspection report, where the inspection report comprises inspection information for one or more messages 112 inspected by the IDS 110. In one embodiment, the inspection information may comprise origin time values. The security monitor 1002 may update the matrix 1400 with the collected origin time values from the inspection reports. If there is a mismatch on a row, then the security monitor 1002 may trigger an alarm and identify which of the relay nodes modified the origin timestamp.

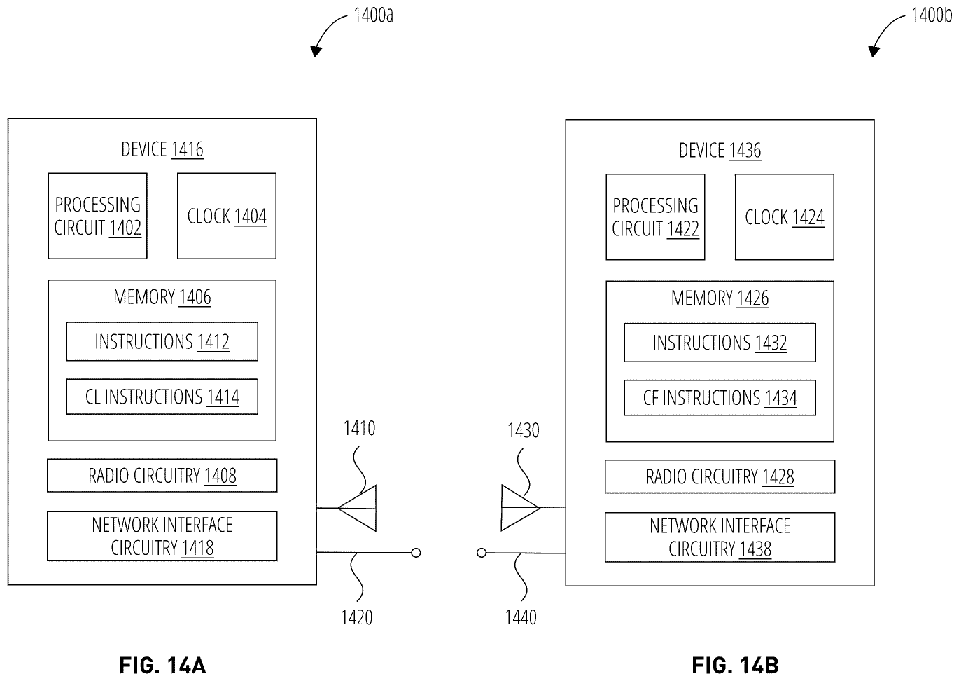

FIG. 14A depicts a device 1416. The device 1416 could be a network node or one of the switches in a TSN network (e.g., TSN nodes 104, clock leader node 202, relay nodes 204a-c, clock follower node 206, relay node 302, TSN nodes 104, apparatus 500, system 600, system 700, system 800, system 1000 or system 1100). Device 1416 includes a processing circuit 1402, a clock 1404, memory 1406, radio circuitry 1408, an antenna 1410, a network interface circuitry 1418, and a wired connection 1420. Memory 1406 stores instructions 1412 and CL instructions 1414. During operation, processing circuit 1402 can execute instructions 1412 and/or CL instructions 1414 to cause device 1416 to send timing messages as a clock leader or grand clock leader (e.g., from time measurements from a global clock for a TSN network) to other devices in the TSN network. In some examples, processing circuit 1402 can execute instructions 1412 and/or CL instructions 1414 to cause device 1416 to send time synchronization messages, time update messages, and other timing messages defined by various IEEE standards as discussed herein. Furthermore, processing circuit 1402 can execute instructions 1412 to cause device 1416 to send, via radio circuitry 1408 and antenna 1410 or network interface circuitry 1418 timing messages as the CL for a CF in a TSN network.

FIG. 14B depicts a device 1436. The device 1436 could be one of the network nodes or switches in a TSN network (e.g., TSN nodes 104, clock leader node 202, relay nodes 204a-c, clock follower node 206, relay node 302, TSN nodes 104, apparatus 500, system 600, system 700, system 800, system 1000, or system 1100). Device 1436 includes a processing circuit 1422, a clock 1424, memory 1426, radio circuitry 1428, an antenna 1430, a network interface circuitry 1438, and a wired connection 1440. Memory 1426 stores instructions 1432 and CF instructions 1434. During operation, processing circuit 1422 can execute instructions 1432 and/or CF instructions 1434 to cause device 1436 to receive timing messages as a clock follower (e.g., from time measurements from a global clock for a TSN network) from other devices in the TSN network, such as the device 1416. In some examples, processing circuit 1422 can execute instructions 1432 and/or CF instructions 1434 to cause device 1436 to receive time synchronization messages, time update messages, and other timing messages defined by various IEEE standards as discussed herein. Furthermore, processing circuit 1422 can execute instructions 1432 and/or CF instructions 1434 to cause device 1436 to receive, via radio circuitry 1428 and antenna 1430 or network interface circuitry 1438 timing messages as the CF for a CL in a TSN network. In addition, processing circuit 1422 can execute instructions 1432 and/or CF instructions 1434 to cause device 1436 to send, via radio circuitry 1428 and antenna 1430 or network interface circuitry 1438 security messages in response to a security attack, such as alert messages, notification messages, network reconfiguration messages, device isolation messages, model update messages, and other messages in a TSN network.

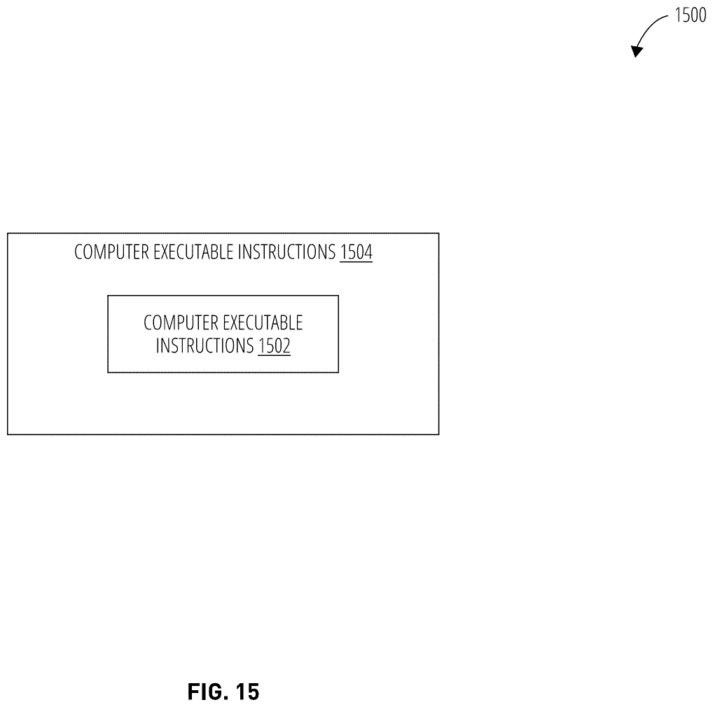

FIG. 15 illustrates computer-readable storage computer-readable medium 1500. Computer-readable storage computer-readable medium 1500 may comprise any non-transitory computer-readable storage medium or machine-readable storage medium, such as an optical, magnetic or semiconductor storage medium. In various embodiments, computer-readable storage computer-readable medium 1500 may comprise an article of manufacture. In some embodiments, computer-readable storage computer-readable medium 1500 may store computer executable instructions 1502 with which circuitry (e.g., processing circuitry 414, processing circuit 1402, processing circuit 1422, radio circuitry 1408, radio circuitry 1428, network interface circuitry 1418, network interface circuitry 1438, clock manager 106, clock circuitry 412, or the like) can execute. For example, computer executable instructions 1502 can include instructions to implement operations described with respect to logic flows 1900 and 2000. Examples of computer-readable storage computer-readable medium 1500 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1502 may include any suitable type of code, such as source code, compiled code, interpreted code, executable code, static code, dynamic code, object-oriented code, visual code, and the like.

The following aspects and examples pertain to further embodiments, from which numerous permutations and configurations will be apparent.

Example 1. A method, comprising: receiving a message with time information at an ingress queue for an ingress interface of an intrusion detection system (IDS), the IDS to monitor a network node of a time-synchronized network (TSN), the time information to comprise information to synchronize a first clock for a clock leader node and a second clock for clock follower node to a network time for the TSN maintained by the first clock; generating an entrance timestamp for the message, the entrance timestamp to comprise a time value representing when the message is received at the ingress queue of the ingress interface of the IDS; inspecting the message for indications of a security attack by the IDS; generating an exit timestamp for the message, the exit timestamp to comprise a time value representing when the message is received at an egress queue of an egress interface of the IDS; and generating an inspection time interval associated with the IDS, the inspection time interval to represent a time interval between the entrance timestamp and the exit timestamp for the message while transiting the IDS.

Example 2. The method of any previous example including example 1, wherein the message comprises a synchronization message, a follow up message, a pdelay request message, a pdelay response message, a delay response follow up message, delay mechanism messages, network-delay measurement mechanism messages, peer delay messages, path delay messages, network delay messages, end-to-end (E2E) messages, peer-to-peer (P2P) messages.

Example 3. The method of any previous example including example 1, comprising generating the entrance timestamp for the message using a start value of a monotonic clock and the exit timestamp for the message using an end value of the monotonic clock.

Example 4. The method of any previous example including example 1, comprising calculating one or more key performance indicators from within the IDS for the network node.

Example 5. The method of any previous example including example 1, comprising calculating multiple key performance indicators from within the IDS for the network node, the key performance indicators to comprise a frequency offset key performance indicator (KPI), a correction time KPI, a phase offset KPI, a link delay KPI, or a rate ratio KPI.

Example 6. The method of any previous example including example 1, comprising determining whether the message is a benign message or a malicious message based on the inspection of the message or multiple messages including the message.

Example 7. The method of any previous example including example 1, comprising updating a correction value within a correction field for the message with the inspection time interval based on the inspection of the message.

Example 8. The method of any previous example including example 1, comprising: determining the message is a benign message based on the inspection of the message; updating a correction value within a correction field for the message with the inspection time interval; and sending the message with the updated correction value from the egress queue of the egress interface of the IDS to the network node.

Example 9. The method of any previous example including example 1, comprising: determining the message is a malicious message based on the inspection of the message; and dropping the message from the egress queue of the egress interface so that the message is not sent from the egress interface of the egress interface of the IDS to the network node.

Example 10. The method of any previous example including example 1, comprising: determining the message is a malicious message based on the inspection of the message; correcting the malicious message to a corrected message; updating a correction value within a correction field for the corrected message with the inspection time interval; and sending the corrected message with the updated correction value from the egress queue of the egress interface of the IDS to the network node.

Example 11. The method of any previous example including example 1, comprising: determining the message is a malicious message based on the inspection of multiple messages using a time series analysis, machine-learning analysis, or a set of heuristics; correcting the malicious message to a corrected message; updating a correction value within a correction field for the corrected message with the inspection time interval; and sending the corrected message with the updated correction value from the egress queue of the egress interface of the IDS to the network node.

Example 12. The method of any previous example including example 1, wherein the IDS monitors an ingress port of the network node of the TSN.

Example 13. The method of any previous example including example 1, wherein the IDS monitors an egress port of the network node of the TSN.

Example 14. The method of any previous example including example 1, wherein the IDS monitors both an ingress port and an egress port of the network node of the TSN.

Example 15. The method of any previous example including example 1, comprising: generating an inspection report by the IDS, the inspection report to comprise inspection information for one or more messages inspected by the IDS; and sending the inspection report from the IDS to a global monitoring system for the TSN.

Example 16. The method of any previous example including example 1, comprising: determining the message is a malicious message based on the inspection of the message; incrementing a count of synchronization cycles associated with a current number of previously received malicious messages; comparing the count of synchronization cycles to a defined threshold value; and generating an alarm when the count of synchronization cycles is greater than or equal to the defined threshold value.

Example 17. The method of any previous example including example 1, comprising: determining a link delay value associated with the message; and sending the link delay value to a global monitoring system for the TSN.

Example 18. The method of any previous example including example 1, comprising: determining a residence time value associated with the message; and sending the residence time value to a global monitoring system for the TSN.

Example 19. The method of any previous example including example 1, comprising: determining an origin time value associated with the message; and sending the origin time value to a global monitoring system for the TSN.

Example 20. A computing apparatus comprising: a processor circuitry; and a memory communicatively coupled to the processor circuitry, the memory storing instructions that, when executed by the processor circuitry, cause the processor circuitry to: receive a message with time information at an ingress queue for an ingress interface of an intrusion detection system (IDS), the IDS to monitor a network node of a time-synchronized network (TSN), the time information to comprise information to synchronize a first clock for a clock leader node and a second clock for clock follower node to a network time for the TSN maintained by the first clock; generate an entrance timestamp for the message, the entrance timestamp to comprise a time value representing when the message is received at the ingress queue of the ingress interface of the IDS; inspect the message for indications of a security attack by the IDS; generate an exit timestamp for the message, the exit timestamp to comprise a time value representing when the message is received at an egress queue of an egress interface of the IDS; and generate an inspection time interval associated with the IDS, the inspection time interval to represent a time interval between the entrance timestamp and the exit timestamp for the message while transiting the IDS.

Example 21. The computing apparatus of any previous example including example 20, wherein the message comprises a synchronization message, a follow up message, a pdelay request message, a pdelay response message, a delay response follow up message, delay mechanism messages, network-delay measurement mechanism messages, peer delay messages, path delay messages, network delay messages, end-to-end (E2E) messages, peer-to-peer (P2P) messages.

Example 22. The computing apparatus of any previous example including example 20, comprising generate the entrance timestamp for the message using a start value of a monotonic clock and the exit timestamp for the message using an end value of the monotonic clock.

Example 23. The computing apparatus of any previous example including example 20, comprising calculate one or more key performance indicators from within the IDS for the network node.

Example 24. The computing apparatus of any previous example including example 20, comprising calculate multiple key performance indicators from within the IDS for the network node, the key performance indicators to comprise a frequency offset key performance indicator (KPI), a correction time KPI, a phase offset KPI, a link delay KPI, a rate ratio KPI, a residence time KPI, or a path delay KPI.

Example 25. The computing apparatus of any previous example including example 20, comprising determine whether the message is a benign message or a malicious message based on the inspection of the message or multiple messages.

Example 26. The computing apparatus of any previous example including example 20, comprising update a correction value within a correction field for the message with the inspection time interval based on the inspection of the message.

Example 27. The computing apparatus of any previous example including example 20, comprising: determine the message is a benign message based on the inspection of the message; update a correction value within a correction field for the message with the inspection time interval; and send the message with the updated correction value from the egress queue of the egress interface of the IDS to the network node.

Example 28. The computing apparatus of any previous example including example 20, comprising: determine the message is a malicious message based on the inspection of the message; and drop the message from the egress queue of the egress interface so that the message is not sent from the egress interface of the egress interface of the IDS to the network node.

Example 29. The computing apparatus of any previous example including example 20, comprising: determine the message is a malicious message based on the inspection of the message; correct the malicious message to a corrected message; update a correction value within a correction field for the corrected message with the inspection time interval; and send the corrected message with the updated correction value from the egress queue of the egress interface of the IDS to the network node.

Example 30. The computing apparatus of any previous example including example 20, comprising: determine the message is a malicious message based on the inspection of multiple messages using a time series analysis, machine-learning analysis, or a set of heuristics; correct the malicious message to a corrected message; update a correction value within a correction field for the corrected message with the inspection time interval; and send the corrected message with the updated correction value from the egress queue of the egress interface of the IDS to the network node.

Example 31. The computing apparatus of any previous example including example 20, wherein the IDS monitors an ingress port of the network node of the TSN.

Example 32. The computing apparatus of any previous example including example 20, wherein the IDS monitors an egress port of the network node of the TSN.

Example 33. The computing apparatus of any previous example including example 20, wherein the IDS monitors both an ingress port and an egress port of the network node of the TSN.

Example 34. The computing apparatus of any previous example including example 20, comprising: generate an inspection report by the IDS, the inspection report to comprise inspection information for one or more messages inspected by the IDS; and send the inspection report from the IDS to a global monitoring system for the TSN.

Example 35. The computing apparatus of any previous example including example 20, comprising: determine the message is a malicious message based on the inspection of the message; increment a count of synchronization cycles associated with a current number of previously received malicious messages; compare the count of synchronization cycles to a defined threshold value; and generate an alarm when the count of synchronization cycles is greater than or equal to the defined threshold value.

Example 36. The computing apparatus of any previous example including example 20, comprising: determine a link delay value associated with the message; and send the link delay value to a global monitoring system for the TSN.

Example 37. The computing apparatus of any previous example including example 20, comprising: determine a residence time value associated with the message; and send the residence time value to a global monitoring system for the TSN.

Example 38. The computing apparatus of any previous example including example 20, comprising: determine an origin time value associated with the message; and send the origin time value to a global monitoring system for the TSN.

Example 39. A non-transitory computer-readable storage medium, the computer-readable storage medium including instructions that when executed by a computer, cause the computer to: receive a message with time information at an ingress queue for an ingress interface of an intrusion detection system (IDS), the IDS to monitor a network node of a time-synchronized network (TSN), the time information to comprise information to synchronize a first clock for a clock leader node and a second clock for clock follower node to a network time for the TSN maintained by the first clock; generate an entrance timestamp for the message, the entrance timestamp to comprise a time value representing when the message is received at the ingress queue of the ingress interface of the IDS; inspect the message for indications of a security attack by the IDS; generate an exit timestamp for the message, the exit timestamp to comprise a time value representing when the message is received at an egress queue of an egress interface of the IDS; and generate an inspection time interval associated with the IDS, the inspection time interval to represent a time interval between the entrance timestamp and the exit timestamp for the message while transiting the IDS.

Example 40. The computer-readable storage medium of any previous example including example 39, wherein the message comprises a synchronization message, a follow up message, a pdelay request message, a pdelay response message, a delay response follow up message, delay mechanism messages, network-delay measurement mechanism messages, peer delay messages, path delay messages, network delay messages, end-to-end (E2E) messages, peer-to-peer (P2P) messages.

Example 41. The computer-readable storage medium of any previous example including example 39, comprising generate the entrance timestamp for the message using a start value of a monotonic clock and the exit timestamp for the message using an end value of the monotonic clock.

Example 42. The computer-readable storage medium of any previous example including example 39, comprising calculate one or more key performance indicators from within the IDS for the network node.

Example 43. The computer-readable storage medium of any previous example including example 39, comprising calculate multiple key performance indicators from within the IDS for the network node, the key performance indicators to comprise a frequency offset key performance indicator (KPI), a correction time KPI, a phase offset KPI, a link delay KPI, or a rate ratio KPI.

Example 44. The computer-readable storage medium of any previous example including example 39, comprising determine whether the message is a benign message or a malicious message based on the inspection of the message.

Example 45. The computer-readable storage medium of any previous example including example 39, comprising update a correction value within a correction field for the message with the inspection time interval based on the inspection of the message.

Example 46. The computer-readable storage medium of any previous example including example 39, comprising: determine the message is a benign message based on the inspection of the message; update a correction value within a correction field for the message with the inspection time interval; and send the message with the updated correction value from the egress queue of the egress interface of the IDS to the network node.

Example 47. The computer-readable storage medium of any previous example including example 39, comprising: determine the message is a malicious message based on the inspection of the message; and drop the message from the egress queue of the egress interface so that the message is not sent from the egress interface of the egress interface of the IDS to the network node.

Example 48. The computer-readable storage medium of any previous example including example 39, comprising: determine the message is a malicious message based on the inspection of the message; correct the malicious message to a corrected message; update a correction value within a correction field for the corrected message with the inspection time interval; and send the corrected message with the updated correction value from the egress queue of the egress interface of the IDS to the network node.

Example 49. The computer-readable storage medium of any previous example including example 39, comprising: determine the message is a malicious message based on the inspection of multiple messages using a time series analysis, machine-learning analysis, or a set of heuristics; correct the malicious message to a corrected message; update a correction value within a correction field for the corrected message with the inspection time interval; and send the corrected message with the updated correction value from the egress queue of the egress interface of the IDS to the network node.

Example 50. The computer-readable storage medium of any previous example including example 39, wherein the IDS monitors an ingress port of the network node of the TSN.

Example 51. The computer-readable storage medium of any previous example including example 39, wherein the IDS monitors an egress port of the network node of the TSN.

Example 52. The computer-readable storage medium of any previous example including example 39, wherein the IDS monitors both an ingress port and an egress port of the network node of the TSN.

Example 53. The computer-readable storage medium of any previous example including example 39, comprising: generate an inspection report by the IDS, the inspection report to comprise inspection information for one or more messages inspected by the IDS; and send the inspection report from the IDS to a global monitoring system for the TSN.

Example 54. The computer-readable storage medium of any previous example including example 39, comprising: determine the message is a malicious message based on the inspection of the message; increment a count of synchronization cycles associated with a current number of previously received malicious messages; compare the count of synchronization cycles to a defined threshold value; and generate an alarm when the count of synchronization cycles is greater than or equal to the defined threshold value.

Example 55. The computer-readable storage medium of any previous example including example 39, comprising: determine a link delay value associated with the message; and send the link delay value to a global monitoring system for the TSN.

Example 56. The computer-readable storage medium of any previous example including example 39, comprising: determine a residence time value associated with the message; and send the residence time value to a global monitoring system for the TSN.

Example 57. The computer-readable storage medium of any previous example including example 39, comprising: determine an origin time value associated with the message; and send the origin time value to a global monitoring system for the TSN.

It may be appreciated that any of the previous examples 1-57 may be implemented as systems and/or means plus function embodiments. Embodiments are not limited to these examples.

What is claimed is:

1. A method, comprising:
receiving a message with time information at an ingress queue for an ingress interface of an intrusion detection system (IDS), the IDS to monitor a network node of a time-synchronized network (TSN), the time information to comprise information to synchronize a first clock for a clock leader node and a second clock for clock follower node to a network time for the TSN maintained by the first clock;
generating an entrance timestamp for the message;
inspecting the message for indications of a security attack by the IDS;
generating an exit timestamp for the message; and
generating an inspection time interval associated with the IDS, the inspection time interval to represent a time interval between the entrance timestamp and the exit timestamp for the message while transiting the IDS.

2. The method of claim 1, wherein the message comprises a synchronization message, a follow up message, a pdelay request message, a pdelay response message, a delay response follow up message, delay mechanism messages, network-delay measurement mechanism messages, peer delay messages, path delay messages, network delay messages, end-to-end (E2E) messages, peer-to-peer (P2P) messages.

3. The method of claim 1, comprising generating the entrance timestamp for the message using a start value of a monotonic clock and the exit timestamp for the message using an end value of the monotonic clock.

4. The method of claim 1, comprising calculating one or more key performance indicators from within the IDS for the network node.

5. The method of claim 1, comprising calculating multiple key performance indicators from within the IDS for the network node, the key performance indicators to comprise a frequency offset key performance indicator (KPI), a correction time KPI, a phase offset KPI, a link delay KPI, or a rate ratio KPI.

6. The method of claim 1, comprising determining whether the message is a benign message or a malicious message based on the inspection of the message or multiple messages including the message.

7. The method of claim 1, comprising updating a correction value within a correction field for the message with the inspection time interval based on the inspection of the message.

8. The method of claim 1, comprising:
determining the message is a benign message based on the inspection of the message;
updating a correction value within a correction field for the message with the inspection time interval; and
sending the message with the updated correction value from the egress queue of the egress interface of the IDS to the network node.

9. A computing apparatus comprising:
a processor circuitry; and
a memory communicatively coupled to the processor circuitry, the memory storing instructions that, when executed by the processor circuitry, cause the processor circuitry to:
receive a message with time information at an ingress queue for an ingress interface of an intrusion detection system (IDS), the IDS to monitor a network node of a time-synchronized network (TSN), the time information to comprise information to synchronize a first clock for a clock leader node and a second clock for clock follower node to a network time for the TSN maintained by the first clock;
generate an entrance timestamp for the message;
inspect the message for indications of a security attack by the IDS;
generate an exit timestamp for the message; and
generate an inspection time interval associated with the IDS, the inspection time interval to represent a time interval between the entrance timestamp and the exit timestamp for the message while transiting the IDS.

10. The computing apparatus of claim 9, wherein the message comprises a synchronization message, a follow up message, a pdelay request message, a pdelay response message, a delay response follow up message, delay mechanism messages, network-delay measurement mechanism messages, peer delay messages, path delay messages, network delay messages, end-to-end (E2E) messages, peer-to-peer (P2P) messages.

11. The computing apparatus of claim 9, wherein the processor circuitry to generate the entrance timestamp for the message using a start value of a monotonic clock and the exit timestamp for the message using an end value of the monotonic clock.

12. The computing apparatus of claim 9, wherein the processor circuitry to calculate one or more key performance indicators from within the IDS for the network node.

13. The computing apparatus of claim 9, wherein the processor circuitry to calculate multiple key performance indicators from within the IDS for the network node, the key performance indicators to comprise a frequency offset key performance indicator (KPI), a correction time KPI, a phase offset KPI, a link delay KPI, a rate ratio KPI, a residence time KPI, or a path delay KPI.

14. The computing apparatus of claim 9, wherein the processor circuitry to determine whether the message is a benign message or a malicious message based on the inspection of the message or multiple messages.

15. The computing apparatus of claim 9, wherein the processor circuitry to update a correction value within a correction field for the message with the inspection time interval based on the inspection of the message.

16. A non-transitory computer-readable storage medium, the computer-readable storage medium including instructions that when executed by a computer, cause the computer to:
receive a message with time information at an ingress queue for an ingress interface of an intrusion detection system (IDS), the IDS to monitor a network node of a time-synchronized network (TSN), the time information to comprise information to synchronize a first clock for a clock leader node and a second clock for clock follower node to a network time for the TSN maintained by the first clock;
generate an entrance timestamp for the message, the entrance timestamp to comprise a time value representing when the message is received at the ingress queue of the ingress interface of the IDS;
inspect the message for indications of a security attack by the IDS;
generate an exit timestamp for the message, the exit timestamp to comprise a time value representing when the message is received at an egress queue of an egress interface of the IDS; and
generate an inspection time interval associated with the IDS, the inspection time interval to represent a time interval between the entrance timestamp and the exit timestamp for the message while transiting the IDS.

17. The computer-readable storage medium of claim 16, wherein the message comprises a synchronization message, a follow up message, a pdelay request message, a pdelay response message, a delay response follow up message, delay mechanism messages, network-delay measurement mechanism messages, peer delay messages, path delay messages, network delay messages, end-to-end (E2E) messages, peer-to-peer (P2P) messages.

18. The computer-readable storage medium of claim 16, wherein the computer to generate the entrance timestamp for the message using a start value of a monotonic clock and the exit timestamp for the message using an end value of the monotonic clock.

19. The computer-readable storage medium of claim 16, wherein the computer to calculate one or more key performance indicators from within the IDS for the network node.

20. The computer-readable storage medium of claim 16, wherein the computer to calculate multiple key performance indicators from within the IDS for the network node, the key performance indicators to comprise a frequency offset key performance indicator (KPI), a correction time KPI, a phase offset KPI, a link delay KPI, or a rate ratio KPI.
